(19) United States
(12) Patent Application Publication
(10) Pub. No.: US 2022/0247551 A1
(43) Pub. Date: Aug. 4, 2022

(54) METHODS AND SYSTEMS FOR PRIVACY PRESERVING EVALUATION OF MACHINE LEARNING MODELS

(71) Applicant: ONESPAN NV, Grimbergen (BE)

(72) Inventors: Marc JOYE, Woluwe-St-Pierre (BE); Fabien A. P. PETITCOLAS, Grimbergen (Strombeek-Bever) (BE)

(73) Assignee: ONESPAN NV, Grimbergen (BE)

(21) Appl. No.: 17/605,836

(22) PCT Filed: Apr. 23, 2020
(86) PCT No.: PCT/EP2020/061407

§ 371 Date: Oct. 22, 2021

(30) Foreign Application Priority Data
Apr. 23, 2019 (EP) 19170720.7
Sep. 20, 2019 (EP) 19198818.7
Sep. 26, 2019 (EP) 19199985.3

(51) Int. Cl. H04L 9/00

(52) U.S. Cl. CPC H04L 9/008

(57) ABSTRACT

Methods and systems are provided for evaluating Machine Learning models in a Machine-Learning-As-A-Service context, whereby the secrecy of the parameters of the Machine Learning models and the privacy of the input data fed to the Machine Learning model are preserved as much as possible, while requiring the exchange between a client and an MLaaS server of as few messages as possible. The provided methods and systems are based on the use of additive homomorphic encryption in the context of Machine Learning models that are equivalent to models that are based on the evaluation of an inner product of on the one hand a vector that is a function of extracted client data and on the other hand a vector of model parameters. In some embodiments the client computes an inner product of extracted client data and a vector of model parameters that are encrypted with an additive homomorphic encryption algorithm. In some embodiments the server computes an inner product of extracted client data that are encrypted with an additive homomorphic encryption algorithm and a vector of model parameters.

### 1 INTRODUCTION

The invention is related to the evaluation, for a set of data gathered in relation to a particular task or problem, of a data model that is parameterized for the type of task or problem that this particular task or problem belongs to, whereby a client and a server interact to obtain the evaluation of the parameterized data model for the set of gathered data, whereby the client has access to the gathered data and the server has access to the data model parameters. While the focus in the following paragraphs that describe the context of the invention is mainly on Machine Learning data models, this is for illustrative purposes only and shall not be understood as a limitation of the invention. The invention can equally well be applied for the evaluation of other types of parameterized data models. In particular, it is not a requirement nor a limitation of the invention that the values of the parameters of the data model are obtained in a training phase or a learning phase using some Machine Learning techniques. The invention does not depend on and is not limited by how the values of the data model parameters are obtained, determined or tuned. Where in the following paragraphs the class of Machine Learning data models is mentioned in relation to the invention, this shall be understood as merely a non-limiting illustrative example representing parameterized data models in general.

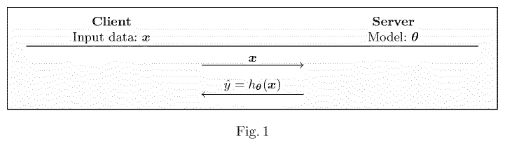

The popularity and hype around Machine Learning, combined with the explosive growth of user-generated data is pushing the development of machine, learning as a service (MLaaS). An example of a typical high level MLaaS architecture is shown in FIG. 1. It involves a client and a MLaaS service provider (server). The service provider owns and runs a trained Machine Learning model for a given type of task (e.g., medical diagnosis, credit worthiness analysis, user authentication, risk profiling in the realm of law enforcement, . . . ). The client gathers data related to a particular task of the given task type and sends a set of input data (in FIG. 1 represented by the vector x) representing the gathered data to the server provider for analysis by the service provider's Machine Learning model (represented in the figure by the function ho(x) parameterized by the vector of model parameters θ). The service provider, more in particular an MLaaS server operated by the MLaaS service provider, applies the Machine Learning model to the task input data received from the client, i.e, the MLaaS server evaluates the Machine Learning model for the received input data, and returns the result of the evaluation (represented in the figure by the prediction value ŷ=h_{θ}(x)) to the client.

In many cases, an MLaaS service provider may have had to invest considerable resources in developing and training an appropriate data model such as a Machine Learning model for a particular type of task. As a consequence, the trained Machine Learning model may constitute a valuable business asset and any information regarding the inner workings of the trained Machine Learning model, in particular the values of parameters that have been tuned in the learning phase, may therefore constitute a trade secret. To preserve this asset and the associated trade secret, it may therefore by important for the MLaaS service provider that any information on the Machine Learning model remains confidential or secret, even to clients using the MLaaS services.

On the other hand, for certain types of tasks (for example of a medical or financial nature) the input data (such as medical, financial or other personal data) related to a particular task and/or the result of evaluating the MLaaS Machine Learning model for a particular task may be sensitive data that for privacy or security or other reasons may have to be kept secret even from the MLaaS service provider analysing these data.

It is furthermore desirable that a MLaaS service can be operated in an efficient way, i.e., that the MLaaS service operates fast, reliable and cost-effective.

What are therefore needed are solutions for the evaluation of trained Machine Learning models that ideally satisfy the following requirements:

1. Input confidentiality The server does not learn anything about the input data x provided by the client;
2. Output confidentiality The server does not learn the outcome y of the calculation;
3. Minimal model leakageThe client does not learn any other information about the model beyond what is revealed by the successive outputs.

With respect to the issue of model leakage, it is noted that the client gets access to the result of the evaluation of the Machine Learning model, i.e., the value of h_{θ}(x), which may leak information about the parameters of the Machine Learning model, i.e., θ, violating Requirement 3. In particular, when h_{θ}is injective, the client could query many times the server using carefully chosen input vectors x (e.g., any set of linearly independent vectors forming a basis of the vector space) to deduce the actual value of θ. In some applications, this is unavoidable, for instance in the case of logistic regression when the client needs to know the value of σ(θ′x)—where σ is the logistic function. Possible counter-measures to limit the leakage include rounding the output or adding some noise to it [20].

At first, one could compare this problem to secure two-party computation (2PC). The archetype application example of 2PC is Yao's millionaire problem in which two parties each know a value and wish to compare it to the value know by the other, without revealing those values to each other. In the general case, multi-party computation requires numerous interactions between the involved parties.

Recent advances in cryptography provide an alternative approach to enable privacy, In particular, fully homomorphic encryption [8] allows the recipient to directly operate on encrypted data without ever decrypting. Privacy guarantees are therefore optimal since everything remains encrypted end-to-end. The problem with solutions based on fully homomorphic encryption is that they are too computationally intensive.

Earlier work related to privacy preservation in the context of Machine Learning [2,16] was concerned with the training of models in a privacy-preserving manner, i.e., with the preservation of the privacy of the training data. More recent implementations for linear regression, logistic regression, as well as neural networks are offered by SecureML [17]. The case of Support Vector Machines (SVM) is for example covered in [22].

The presently described invention however deals with the problem of privately evaluating a parameterized data model such as a Machine Learning model, including linear/logistic regression, SVM classification and neural networks. In [4], Bos et al. suggest to evaluate a logistic regression model by replacing the sigmoid function with its Taylor series expansion. They then apply fully homomorphic encryption so as to get the output result through a series of multiplications and additions over encrypted data. They observe that using terms up to degree 7 the Taylor expansion gives roughly two digits of accuracy to the right decimal. Kim et al. [15] argue that such an expansion does not provide enough accuracy on real-world data sets and propose another polynomial approximation.

The presently described invention provides privacy-preserving solutions, methods, protocols and systems for the evaluation of a variety of parameterized data models such as Machine Learning models. An important element of the solutions, methods, protocols and systems of the present invention, is that they only make use of additively homomorphic encryption (i.e., homomorphic encryption supporting additions). In other words, the solutions, methods, protocols and systems of the present invention don't make use of homomorphic multiplications over encrypted data (i.e., a homomorphic multiplication whereby the factors are both homomorphically encrypted, not to be confused with the scalar multiplication of an encrypted data value with an integer scalar whereby the integer scalar is not encrypted and which is a repeated homomorphic addition of the encrypted data value to itself), only homomorphic additions over encrypted data. They therefore feature better performance (in terms of communication and/or computational efficiency) than solutions building upon more general privacy-preserving techniques such as fully homomorphic encryption (i.e., homomorphic encryption supporting not only additions but also multiplications) and the likes. Furthermore, they limit the number of interactions between the involved parties.

In terms of security, the inventors have made the assumption that both the client and the server are honest but curious, that is, they both follow the protocol but may record information all along with the aim, respectively, to learn the model parameters and to breach the client's privacy.

ORGANISATION. The rest of this description is organised as follows. In Section 2, a short summary of important Machine Learning techniques is given for which we will propose secure protocols, In Section 3, cryptographic tools are described that will be used as building blocks for some of the presently described embodiments of the invention. In Section 4 a summary of the invention is given. In Section 5, three exemplary families of embodiments of the invention comprising protocols for private inference or evaluation of parameterized data models are described. They do not depend on any particular additively homomorphic encryption scheme. In Section 6 these protocols are applied to the private evaluation of neural networks.

List of Notations

| Explanation | Notation |
|---|---|
| Vector and its n + 1 coordinates | a = (a₀, a₁, . . . , aₙ) |
| Matrix | A |
| Transpose of a vector | a^{T} |
| Target function | ƒ |
| Input data | x ∈ [symbol] |
| Value of j-th unit in l-th layer in | x₍ⱼ₎^{(l)} |
| Neural Network | |
| Training data vectors | xᵢ |
| Output data | y ∈ [symbol] |
| Model for a single class | θ |
| Set of plaintext messages | [symbol] = {−└M/2┘, . . . , ┌M/2┐ − 1} |
| Set of ciphertexts | [symbol] |
| Upper bound on the inner product | B |
| (in absolute value) | |
| Model for a several classes or | θₖ |
| hidden layers | |
| Estimation function | h_{θ}(x) ≈ ƒ(x). |
| | Examples: h_{θ}(x) = θ^{T} x, |
| | h_{θ}(x) = sign(θ^{T} x) |
| Linear ML | h_{θ}(x) = g(θ^{T} x) |
| Estimated value | ŷ = h_{θ}(x) |
| Slack variables | ξᵢ |
| Pick randomly from set | [symbol] |
| Encryption with public key pk | [symbol] → [symbol] |
| | [symbol] · [symbol] ₚₖ and [symbol] · [symbol] ₚₖ |
| Decryption with private key sk | [symbol] → [symbol] |
| | [symbol] · [symbol] ₛₖ and [symbol] · [symbol] ₛₖ |
| Message | m ∈ [symbol] , m ∈ [symbol] ^{d} |
| Encrypted message | m ∈ [symbol] , m ∈ [symbol] ^{d} |
| Masked value of h | h* |
| Inner product | t = θ^{T} x |
| Masking value | μ |
| Bits of μ | μᵢ |
| Masked inner product | t* = t + μ |
| Encryption of x, t, t* | [symbol] = [symbol] x [symbol] , t = [symbol] t [symbol] , t* = [symbol] t* [symbol] |
| Indices | μᵢ (bits) |
| | xᵢ (training point), |
| | x_{i, j} (training points coordinates) |
| | x^{(l)} (l-th hidden layer) |

### Linear Models and Beyond

Owing to their simplicity, linear models should not be overlooked: They are powerful tools for a variety of Machine Learning tasks and find numerous applications, including IoT applications that go beyond basic statistics. We refer the reader to [1, Chapter 3] or [12, Chapters 3 and 4], both included herein by reference, for a good introduction to linear models.

This section reviews some important types of Machine Learning models, which all rely on the computation of an inner product.

### 2.1 Problem Setup

In a nutshell, Machine Learning works as follows. Each particular problem instance is characterised by a set of d features which may have been extracted from a set of raw data gathered in relation to that particular problem instance (e.g., in the context of estimating the credit worthiness of a particular person such data may comprise data related to the occupation, income level, age, number of dependants, . . . of that particular person). The set of d features may be viewed as a vector (x₁, . . . , x_{d})^{T} of [symbol] . For practical reasons, a fixed coordinate x₀=1 may be added. We let X {1}× [symbol] ^{d} . denote the input space and [symbol] the output space. Integer d is called the dimensionality of the input data. There are two phases:
The learning phase (a.k.a. training phase) consists in approximating a target function ƒ: X→ [symbol] from a training set of η pairs of elements

$$𝒟 = {\{ ( {x}_{i} , {y}_{i} ) ∈ 𝒳 \times 𝒴 \vert {y}_{i} = f ( {x}_{i} ) \}}_{1 ⩽ i ⩽ n} .$$

Note that the target function can be noisy. The output of the learning phase is a function h_{θ}:X→ [symbol] drawn from some hypothesis set of functions, As has already been noted before, the particular way that the parameters of a data model are obtained is not relevant for the invention. In particular, with respect to the invention the parameters of a Machine Learning data model or another type of data model may be determined in another way than in the way described in the above description of the learning phase or training phase of a Machine Learning data model.
In the testing phase, when a new data point x ΕX comes in, it is evaluated on h_{θ}as ŷ=h_{θ}(x). The hat on variable y indicates that it is a predicted value.

Since h_{θ} was chosen in a way to “best match” f (according to some predefined criterion) on the training set [symbol] , it is expected that it will provide a good approx-imation on a new data point. Namely, we have ho(xᵢ) y for all (xᵢ, y) ϵ [symbol] and we should have he(x)≈(x) for (x,.) [symbol] . Of course, this highly depends on the problem under consideration, the data points, and the hypothesis set of functions.

In particular, linear models for Machine Learning use a hypothesis set of functions of the form

$${h}_{θ} ( x ) = g ( {θ}^{⊤} x ) \qquad ( 1 )$$

where θ=(θ₀, θ₁, . . . θ_{d}) ∈ [symbol] are the model parameters and g: [symbol] → [symbol] is a function mapping the linear calculation to the output space, In some embodiments of the invention, the model may have other additional parameters than only the parameter values that make up θ. These other additional parameters may be referred to as hyperparameters. These hyperparameters may for example include breakpoints of segmented functions or coefficients of polynomials that are used in the evaluation of the model.

When the range of g is real-valued and thus the prediction result ŷΕ [symbol] is a continuous value (e.g., a quantity or a probability), we talk about regression. When the prediction result is a discrete value (e.g., a label), we talk about classification. An important sub-case is [symbol] ={+1, −1}. Specific choices for g are discussed in the next sections.

### 2.2 Linear Regression

A linear regression model assumes that the real-valued target function ƒ is linear—or more generally affine—in the input variables. In other words, it is based on the premise that f is well approximated by an affine map; i.e., g is the identity map:

$$f ( {x}_{i} ) \approx g ( {θ}^{T} {x}_{i} ) = {θ}^{T} {x}_{i} = {θ}_{0} + {\sum }_{j = 1}^{d} {θ}_{j} {x}_{i , j} , 1 ⩽ i ⩽ n , \qquad ( 2 )$$

for some training data x E X and weight vector θE [symbol] ⁺¹ This vector θ is interesting as it reveals how the output depends on the input variables. In particular, the sign of a coefficient θⱼ indicates either a positive or a negative contribution to the output, while its magnitude captures the relative importance of this contribution.

The linear regression algorithm relies on the least squares method to find the coefficients of θ: it minimises the sum of squared errors Σᵢ₌₁ⁿ (f(xᵢ)−θ^{T}xᵢ)², Once θ has been computed, it can be used to produce estimates on new data points x E X as ŷ=θ^{T}x.

### 2.3 Support Vector Machines

We now turn our attention to another important problem: how to classify data into different classes. This corresponds to a target function f whose range y is discrete. Of particular interest is the case of two classes, say +1 and −1, in which case [symbol] ={+1, −1}. Think for example of a binary decision problem where +1 corresponds to a positive answer and −1 to a negative answer.

In dimension d, an hyperplane H is given by an equation of the form

$${θ}_{0} + {θ}_{1} {X}_{1} + {θ}_{2} {X}_{2} + … + {θ}_{d} {X}_{d} = 0$$

where θ′=(θ₁. . . , θ_{d})^{T} is the normal vector to II and θ₀/∥θ′∥ indicates the offset from the origin.

We suppose first that the training data are linearly separable. This means that there is some hyperplane 11 such that for each (xᵢ, yᵢ) E [symbol] , one has

$$\{ \begin{matrix}{θ}_{0} + {θ}_{1} {x}_{i , 1} + {θ}_{2} {x}_{i , 2} + ⋯ + {θ}_{n} {x}_{i , d} > 0 & if {y}_{i} = + 1 \\ {θ}_{0} + {θ}_{1} {x}_{i , 1} + {θ}_{2} {x}_{i , 2} + ⋯ + {θ}_{n} {x}_{i , d} < 0 & if {y}_{i} = - 1\end{matrix} , \\ 1 ⩽ i ⩽ n , \qquad ( 3 )$$

or equivalently (by scaling θ appropriately):

$${y}_{i} {θ}^{⊤} {x}_{i} ⩾ 1 , 1 ⩽ i ⩽ n .$$

The training data points xᵢ satisfying yᵢθ_{T}xᵢ=1 are called support vectors.

When the training data are not linearly separable, it is not possible to satisfy the previous hard constraint yᵢ O^{r}xᵢ 1, (1 G i G n). So-called “slack variables” Eᵢ=max (0,1−yᵢθ^{T}xᵢ) are generally introduced in the optimisation problem. They tell how large a violation of the hard constraint there is on each training point—note that eᵢ=0 whenever yᵢθ^{T}xi≤1..

There are many possible choices for 0. For better classification, the separating hyperplane H is chosen so as to maximise the margin; namely, the minimal distance between any training data point and H.

Now, from the resulting model θ, when a new data point x comes in, its class is estimated as the sign of the discriminating function θ^{T}x; i.e., Y=sign(θ^{T}x). Compare with Eq. (3).

Remark 1. When there are more than two classes, the optimisation problem returns several vectors θₖ, each defining a boundary between a particular class and all the others. The classification problem becomes an iteration to find out which θₖ maximises θₖ^{T}x for a given test point x.

### 2.4 Logistic Regression

Logistic regression is widely used in predictive analysis to output a probability of occurrence. The logistic function is defined by the sigmoid function

$$σ : ℝ \to [ 0 , 1 ] , t ↦ σ ( t ) = \frac{1}{1 + {e}^{- t}} .$$

The logistic regression model returns ho(x) =o⁻(0′x) E [0, 1], which can be interpreted as the probability that x belongs to the class y =--1. The SVM classifier thresholds the value of O^{r}x around 0, assigning to x the class y =-H1 if O^{r}x >0 and the class y=−1 if 0In this respect, the logistic function is seen as a soft threshold as opposed to the hard threshold, +1 or −1, offered by SVM. Other threshold functions are possible. Another popular soft threshold relies on tanh, the hyperbolic tangent function, whose output range is [−1, 1].

WO 2020/216875 PCT/EP2020/061407

Remark 2. Because the logistic regression algorithm predicts probabilities rather than just classes, it may be fitted through likelihood optimisation. Specifically, given the training set [symbol] , the model may be learnt by maximising _{—ti}° pᵢ) where pᵢ =a(O^{T} xᵢ). This deviates from the general description of Section 2.1_{;} where the learning is directly done on the pairs (xᵢ, yᵢ). However, the testing phase is unchanged: the outcome is expressed as hₑ(x) =o⁻(O^{T}/). It therefore fits our framework for private inference, that is, the private evaluation of ho(x) =g(O^{T} x) for a certain function g. In this case, g is the sigmoid function a.

Cryptographic Tools

This section introduces some building blocks that may be used in some embodiments of the present invention.

### 3.1 Representing Real Numbers

So far, we have discussed a number of types of Machine Learning models that in general take as input real numbers. However, the cryptographic tools we intend to use in some of the described embodiments require working on integers. We therefore introduce a conversion to convert real numbers into integers.

An encryption algorithm takes as input an encryption key and a plaintext message and returns a ciphertext. We let [symbol] C [symbol] denote the set of messages that can be encrypted. In order to operate over encrypted data, we need to accurately represent real numbers as elements of [symbol] (i.e., a finite subset of [symbol] . To ease the presentation and since all input variables of Machine Learning models are t_{y}pically resealed in the range [−1, 1], we assume a fixed point representation. A real number x with a fractional part of at most P bits uniquely corresponds to signed integer z=x·2^{P}. Hence, with a fixed-point representation, a real number x is represented by

$$z = ⌊ x \cdot {2}^{P} ⌋ ,$$

where integer P is called the bit-precision. The sum of xᵢ, x₂ E [symbol] is performed as zⱼ z₂ and their multiplication as [(zᵢ z₂)/2^{P}]. More generally, the product Πxᵢ, (xᵢ ∈ [symbol] ) is performed as. 3.2 Additively Homomorphic Encryption

Homomorphic encryption schemes come in different flavours. Before Gentry's breakthrough result ([8]), only addition operations or multiplication operations on ciphertexts but not both were supported. Schemes that can support an arbitrary number of additions and of multiplications are termed fully homomorphic encryption (FHE) schemes.

Our privacy-preserving protocols only need an additively homomorphic encryption scheme. It is useful to introduce some notation. We let ∥·∥ and ∥·∥ denote the encryption and decryption algorithms, respectively. The message space is an additive group [symbol] ≅ [symbol] /M [symbol] . It consists of integers modulo M. To keep track of the sign, we iew it as [symbol] ={−└M/2┘, . . . , ┐M/2┐−1}. The elements of [symbol] are uniquely identified with [symbol] /M [symbol] via the mapping γ: [symbol] [symbol] [symbol] /M [symbol] , m [symbol] m mod M. The inverse mapping is given by γ⁻¹; [symbol] /M [symbol] [symbol] [symbol] , m [symbol] m if m<┌M/2┐ and m [symbol] m−M otherwise. Ciphertexts are noted with Gothic letters. The encryption of a message m ∈ [symbol] is obtained using public key pk as m= [symbol] m [symbol] ₚₖ. It is then decrypted using the matching secret key sk as m= [symbol] m [symbol] ₛₖ. When clear from the context, we drop the pk or sk subscripts and sometimes use [symbol] . [symbol] and [symbol] . [symbol] to denote another encryption algorithm. If m=(mₗ, . . . m_{d}) ∈ [symbol] ^{d} is a vector, we write m= [symbol] m [symbol] as a shorthand for mₗ, . . . m_{d})=( [symbol] mₗ [symbol] , . . . [symbol] m_{d} [symbol] . Similarly, we use the terminology encrypting an original unencrypted vector m to calculate a vector m= [symbol] m [symbol] , the coordinates (mₗ, . . . m_{d}) of which are the encrypted values of the corresponding coordinates (mₗ, . . . , m_{d}) of the original unencrypted vector m, and we use the terminology encrypted vector to refer to the vector m that results from encrypting the original unencrypted vector m.

Algorithm [symbol] · [symbol] being additively homomorphic (over [symbol] ) means that given any two plaintext messages m₁ and m₂ and their corresponding ciphertexts mᵢ= [symbol] mₗ [symbol] and m₂= [symbol] m₂ [symbol] , we have m₁ [symbol] m₂= [symbol] mₗ+m₂ [symbol] and mₗ [symbol] m₂ = [symbol] m₁−m₂ [symbol] for some publicly known operations [symbol] and [symbol] on ciphertexts. By induction, for a given integer scalar r ∈ [symbol] , we also have the scalar multiplication operation

$$r \cdot {m}_{1} = {m}_{1} + ⋯ + {m}_{1} = {m}_{1} ⋯ {m}_{1} = \underbrace{{m}_{1} ⋯ {m}_{1} }_{r times} := r ⊙ {m}_{1} .$$

It is worth noting here that the decryption of (m₁ [symbol] m₂) gives (m₁+m₂)as an element of [symbol] ; that is, [symbol] m₁ [symbol] m₂ [symbol] ≡m₁+m₂ (mod [symbol] ). Similarly, we also hav [symbol] m₁ [symbol] m₂ [symbol] ≡m₁−m₂ (mod M) and [symbol] r⊙m₁ [symbol] ≡r·m₁ (mod M).

In what follows, the terminology ‘clear value’ is meant to refer to a value in the message space [symbol] , i.e., a decrypted value or a value that is not encrypted.

SEMANTIC SECURITY AND HOMOMORPHIC EQUIVALENCE. In some embodiments of the present invention, the minimal security notion that is required for the additively homomorphic encryption is semantic security [11]. In some embodiments, the additively homomorphic encryption is probabilistic. For some additively homomorphic cryptosystems, in particular additively homomorphic cryptosystems that are semantically secure, while it is true that if a first en crypted value EVₐ = [symbol] v_{α} [symbol] has the same (encrypted) value as a second en crypted value EV_{b} = [symbol] v_{b} [symbol] then it follows automatically that decrypting the first encrypted value EV, will necessarily result in the same clear value as decrypting the second encrypted value EV_{b} (i.e., EV, =EV_{b} and vₐ= [symbol] EVₐ [symbol] and v_{b}= [symbol] EV_{b} [symbol] [symbol] vₐ=v_{b}), the inverse is not true; i.e., for these cryptosystems if a first encrypted value EV₁ is obtained by encrypting a given clear value v and a second encrypted value EV₂ is obtained by encrypting for a second time (using the same encryption algorithm and key) the same clear value v (using the same encryption algorithm and key as the first time), then it does not automatically follow that the second encrypted value will be the same as the first encrypted value; rather the second encrypted value may actually be expected with a high probability to be different from the first encrypted value. In what follows, the terminology “homomorphically equivalent encrypted values” will be used to refer to two encrypted values that may be different but that yield the same clear value when decrypted (using the same decryption algorithm and key). I.e., (EVᵢ is homomorphically equivalent to EV₁ [symbol] ( [symbol] EV₁ [symbol] = [symbol] EV₂ [symbol] . In some instances in this description a first encrypted value may be said (in a broad way) to be equal to a second encrypted value wherey it is clear that what is actually meant is that their respective decrypted values are equal, i.e., that the first encrypted value is homomorphically equivalent to the second encrypted value.

EXAMPLE ADDITIVE HMOMORPHIC CRYPTOSYSTEMS. A good example of an additive homomorphic encryption scheme that may be used in some embodiments is Paillier's cryptosystem [19]. In some embodiments the Benaloh cryptosystem may be used.

In some embodiments of the invention, a fully homomorphic encryption scheme may be used as an additively homomorphic encryption scheme. I.e., in such embodiments, although a fully homomorphic encryption scheme may be used, only the property that the fully homomorphic encryption scheme supports homomorphic addition operations on ciphertexts is used whereas the property that the fully homomorphic encryption scheme also supports homomorphic multiplication operations on cyphertexts is not used. Using in this way a fully homomorphic encryption scheme may be advantageous in some embodiments, for example if for the particular fully homomorphic encryption scheme that is used the addition operations on ciphertexts can be done in a computationally efficient way but the multiplication operations on ciphertexts cannot be done in a computationally efficient way.

### 3.3 Private Comparison Protocol

In some embodiments of the invention, it may be necessary for the client and the server to be able to compare a client value known to the client but not known to the server with a server value known to the server but not known to the client whereby it is not necessary for the client to reveal the actual client value to the server nor for the server to reveal the actual server value to the client. In some embodiments, the client and the server may perform a private comparison protocol to do such a comparison. For the purposes of this description, a private comparison protocol is a protocol performed by a first party and a second party whereby the first party has knowledge of a first numeric value and the second party has knowledge of a second numeric value whereby performing the private comparison protocol enables establishing whether the first numeric value is smaller or equal than the second numeric value without the first party needing knowledge of the second numeric value and without the second party needing knowledge of the first numeric value. Which party gets to know the answer to the question of whether or not the first numeric value is smaller or equal than the second numeric value may differ from one private comparison protocol to another. Some private comparison protocols provide the answer to only one party. Some private comparison protocols provide the answer to both parties. Some private comparison protocols, which in the remainder of this description will be referred to as secret sharing private comparison protocols, provide the first party with a first share of the answer and the second party with a second share of the answer whereby the answer can be obtained by combining the first and second shares of the answer. One party can then obtain the answer if it is given access to the share of the answer known to the other party and combine that share of the other party with its own share. For example in some secret sharing private comparison protocols, the first and second party performing the secret sharing private comparison protocol may result in the first party being provided with a first bit value and the second party being provided with a second bit value whereby the answer to the question of whether or not the first numeric value is smaller or equal than the second numeric value can be obtained by exoring the first and second bit value.

In the following, the DGK+protocol, an example of a secret sharing private comparison protocol, will be described. In [5,6], Damghrd et al. present an efficient protocol for comparing private values. It was later extended and improved in [7] and [21,14]. The protocol makes use of an additively homomorphic encryption scheme such as the one described in Section 3.2. It compares two non-negative [symbol] -bit integers. The message space is [symbol] = [symbol] /M [symbol] with M≥ [symbol] and is supposed to behave like an integral domain (for example, M a prime or an RSA-type modulus).

DGK+PROTOCOL. The setting is as follows. A client possesses a private [symbol] -bit value μ= [symbol] μᵢ 2ⁱ while a server possesses a private [symbol] -bit value η= [symbol] ηᵢ 2ⁱ. The client and the server seek to respectively obtain bits bₑ and 6, such that e b=[p,71] (where e represents the exclusive OR operator, and [Pred] =1 if predicate Pred is true, and 0 otherwise). Following [14, FIG. 1], the DGK+ protocol proceeds in four steps:

1. The client encrypts each bit _{[}Lᵢ of ᵢ under its public key and sends [symbol] μᵢ [symbol] , 0<i [symbol] −1, to the server.

2. The server chooses unpredictably for the client and preferably uniformly at random a bit and defines s=1 2bₛ. Likewise, it also selects [symbol] +1 random non-zero scalars rᵢ ∈ [symbol] , −1, ≤i≤ [symbol] −1.

3. Next, the server computes¹

$$\{ \begin{matrix}\begin{matrix} {h}_{i}^{*} = {r}_{i} ⊙ ( 1 s \cdot {μ}_{i} s \cdot {η}_{i} ( \\ for ℓ - 1 ⩾ i ⩾ 0 ,\end{matrix} \\ {h}_{- 1}^{*} = {r}_{- 1} ⊙ ( {δ}_{S} {μ}_{j} ⊕ {η}_{j} )\end{matrix} \qquad ( 5 )$$

and sends the [symbol] +1 cyphertexts [symbol] hᵢ* [symbol] in a random order to the client. 4. Using its private key, the client decrypts the received [112,1 ‘s. If one is decrypted to zero, the client sets =1. Otherwise, it sets=0.

Remark 3. At this point, neither the client, nor the server, knows whether p holds. One of them (or both) needs to reveal its share of 6 (=e 6,) so that the other can find out, Following the original DGK protocol [5], this modified comparison protocol is secure in the semi-honest model (i.e., against honest but curious adversaries).

CORRECTNESS. The correctness of the protocol follows from the fact that p if only and only if:

p=7), or

there exists some index i, 0≤i≤ [symbol] −1, such that:
μ=η, or
2. pᵢ=for i 1 j 1.

As pointed out in [5], when p 17, this latter condition is equivalent to the existence of some index i E[0, E 1], such that μᵢ−ηᵢ+1+ [symbol] (μⱼ⊕ηⱼ)=0. This test was subsequently replaced in [7,14] to allow the secret sharing of the comparison bit across the client and the server as [p G q]=6,esₛ. Adapting [14], the new test checks the existence of some index i E [0,f1], such that

$${h}_{i} = s ( {μ}_{i} - {η}_{i} ) + 1 + {\sum }_{j = i + 1}^{ℓ - 1} ( {μ}_{j} ⊕ {η}_{j} )$$

is zero. When 6, =0 (and thus s =1) this occurs if p <q; when 6, =1 (s =1) this occurs if p >r₇. As a result, the first case yields 6, =<1₇] =1 e [p <1₇] while the second case yields 6, =[p >7)] =1₇] =1 e [μGμ]. This discrepancy is corrected in [21] by augmenting the set of hᵢ's with an additional value h₋₁ given by h₋₁ =δₛ+ [symbol] (μⱼ⊕ηⱼ). It is worth observing that can only be zero when 6, =0 and p =1₇. Therefore, in all cases, when there exists some index i, with 1 i f 1, such that hᵢ =0, we have 6, =1 ±[p or equivalently, [p <7₇] =6, e 1.

It is easily verified that [symbol] hᵢ* [symbol] as computed in Step 3 is the encryption of rᵢ hᵢ (mod [symbol] ). Clearly, if rᵢ hᵢ (mod Al) is zero then so is hᵢ since, by definition, rᵢ is non-zero remember that M is chosen such that [symbol] /M [symbol] acts as an integral domain. Hence, if one of the decrypts to 0 then p<1=6. if not, one has [p G 7₇] =6, =6, e This concludes the proof of correctness. Note that given [symbol] μᵢ [symbol] , the server can obtain [symbol] ηᵢ⊕μᵢ [symbol] as [symbol] μᵢ [symbol] if ηⁱ =0, and as [symbol] l [symbol] [symbol] [symbol] μⁱ [symbol] if ηᵢ=1.

Remark 4. When the server has no prior knowledge on the Hamming weight of μ, the authors of [14] describe an astute way to halve the number of ciphertexts exchanged between the client and the server. In particular, this applies when p is a random value.

### 3.4 Private Sign Determination Protocols

TERMINOLOGY. In the context of this description, a private sign determination protocol is a protocol between a first and a second entity for determining whether a test value vₜ,ₛₜ is larger or equal than zero, whereby:

the protocol protects the confidentiality or privacy of the test value vₜₑₛₜ towards both the first and the second entity, i.e., the encrypted test value Ptest), encrypted with an additively homomorphic encryption algorithm parameterized with a public key of the first entity, must be known to or accessible by the second entity, but the protocol provides knowledge of the clear value of the test value, i.e. v_{te]},_{t;} to neither the first nor the second entity; the protocol provides the first entity with a first partial response bit b₁, and provides the second entity with a second partial response bit b,; the answer to the question whether the test value vₜₜ is larger or equal than zero is a logical binary function of both the first partial response bit b₁ and the second partial response bit b₂, i.e., [ tiₜₑₛₜ <0] =fanswer b2).

In the context of this description, a secret sharing sign determination protocol is a private sign determination protocol whereby the answer function f answer (b₁, b₂) cannot be reduced to be a function of only one of the partial response bits b₁ or h₂. I.e., for at least one value of at least one of the two partial response bits b₁ or b₂ the value of the answer function f_{answer}(b₁, b₂) changes if the value of the other of the two partial response bits is changed. A truly or fully secret sharing sign determination protocol is a secret sharing sign determination protocol whereby for all possible values combinations of the first and second partial response bits the value of the answer function ƒ_{answer}(b₁, b₂)changes if the value of one of the two partial response bits is changed. For example, in some embodiments f_{answer}(b₁, b₂)=(b₁b₂) or f_{answer}(b₁, b₂) or f₅,(bᵢ, b₂) =(b₁ e b₂). A partially secret sharing sign determination protocol is a secret sharing sign determination protocol whereby there is a value for one of the first or second partial response bits for which the value of the answer function f_{answer} (b₁₁ b₂) does not change if the value of the other one of the two partial response bits is changed, i.e., there is a value for one of the first or second partial response bits for which the other partial response bit is a ‘don't-care’ for the answer function r_{answer} 01 b2). For example, in some ,embodiments f_{answer} (b₁ b′^{,}) =(b₁ A b₂) (if b₁ =0 then b₂ is a ‘don't-care’) or (answer (b1, , b₂) =^{,}(b₁ V b₂) or fₐ,,,,(b₁, b₂) =(^{,}b₁ A b₂).

EXAMPLE. In some embodiments a method for a first entity and a second entity to perform a fully secret sharing sign determination protocol may be based on the

DGK±protocol described elsewhere in this description. In other embodiments a method for a first entity and a second entity to perform a fully secret sharing sign determination protocol may be based on the ‘heuristic’ protocol described elsewhere in this description in the context of SVM classification and Sign Activation of Neural Networks. In some embodiments, a method for a first entity and a second entity to perform a fully secret sharing sign determination protocol wherein the second entity has access to the encrypted test value [symbol] vₜₑₛₜ [symbol] encrypted with an additively homomorphic encryption algorithm parameterized with a public key of the first entity, may comprise the following steps:
the second entity choosing a masking value μ, preferably in a way that is unpredictable to the first entity;
the second entity encrypting the masking value and homomorphically adding the masking value μ to the encrypted test value [symbol] vₜₑₛₜ [symbol] [symbol] μ [symbol] and sending the masked encrypted test value [symbol] vₜₑₛₜ [symbol] [symbol] [symbol] μ [symbol] to the first entity;
the first entity receiving the masked encrypted test value [symbol] vₜₑₛₜ [symbol] [symbol] [symbol] μ [symbol] , decrypting it and setting the value to the decrypted received value (it follows that rⱼ =t:ₜ,ₛₜ -H
the first entity and the second entity performing the DGK±protocol to establish whether ᵣ₁ is larger or equal than p, wherein the first entity obtains a first DGK±result bit Sᵢ and the second entity obtains a second DGK+result bit 6₂ such that.
the first entity setting a first partial response bit bⱼ to the obtained Sᵢ, and the second entity setting a second partial response bit b₂ to the obtained Sᵢ. It follows that the answer to the question whether the test value li_{tcst} is larger or equal than zero is a logical disjunction of the first partial response hit bⱼ and the second partial response bit i.e., b₁ b₂ .

In some embodiments, the masking value p may be chosen as explained in the description of the Second ‘Core’ Protocol for Private SVM Classification elsewhere in this description.

### 3.5 Private Conditional Selection Protocols

TERMINOLOGY. In the context of this description, a private conditional selection protocol is a protocol between a first and a second entity for selecting one of a first encrypted target value ∥v₂∥ and a second encrypted target value wherein both the first and second encrypted target values are encrypted with an additively homomorphic encryption algorithm parameterized with a public key of a public-private key pair of the first entity and wherein the encrypted values of the first and second target values are known to the second entity, whereby the second encrypted target values ∥v₂∥ is selected if a test value vₜₑₛₜ is larger or equal than a reference value r_{ref} and the first encrypted target values ∥v₁∥ is selected otherwise, and whereby:
the protocol protects the confidentiality or privacy of the test value vₜₑₛₜ towards both the first and the second entity, i.e., the second entity must know or have access to the encrypted test value ( [symbol] vₜₑₛₜ [symbol] ) encrypted with the additively homomorphic encryption algorithm parameterized with the public key of the first entity, but neither the first entity nor the second entity require knowledge of or access to the clear value of the test value, i.e. vₜₜ, and neither the first nor the second entity get knowledge of or access to the clear value of the test value by performing the protocol.

Second entity obtains a homomorphic equivalent of the selected encrypted target value. In some private conditional selection protocols, the second entity obtains an encrypted result value [Ivₛᵤᵢₜli encrypted with the additively homomorphic encryption algorithm parameterized with the public key of the first entity, whereby the clear result value 7 iresult (i.e. the clear value resulting from decryption with the private key of the first entity of said encrypted result value), is equal to the clear selected target value (i.e. the clear value resultin from decryption with said private key of the selected encrypted target value).

Privacy of the target values. Some private conditional selection protocols don't provide the second entity with access to the first clear value v₁. Some private conditional selection protocols don't provide the second entity with access to the second clear value v₂. Some private conditional selection protocols don't provide the first entity with access to the first encrypted value [symbol] v₁ [symbol] nor to the first clear value v₁. Some private conditional selection protocols don't provide the first entity with access to the second encrypted value [symbol] v₂ [symbol] nor to the second clear value v₂.

Privacy of the result of the comparison towards the first entiy, Some private conditional selection protocols provide confidentiality or privacy of the comparison of the test value and the reference value with respect to the first entity. I.e., such private conditional selection protocols don't provide the first entity with the knowledge whether the test value vₜ is larger or equal than the reference value v_{ref}, nor with the knowledge which of the first or second encrypted target value is selected.

Privacy of the result of the comparison towards the second entity. Some private conditional selection protocols provide confidentiality or privacy of the comparison of the test value and the reference value with respect to the second entity, I.e., such private conditional selection protocols don't provide the second entity with the knowledge whether the test value τₜₑₛₜ is larger or equal than the reference value v_{ref}, nor with the knowledge which of the first or second encrypted target value is selected.

Privacy of the reference value. Some private conditional selection protocols provide confidentiality or privacy of the reference value with respect to the first entity. I.e., such private conditional selection protocols don't provide the first entity with access to the clear value of the reference value v_{ref} nor with access to an encrypted value of the reference value ∥v_{ref}∥ (encrypted with the additively homomorphic encryption algorithm parameterized with the public key of the first entity). In some private conditional selection protocols, the second entity doesn't have access to the clear value of the reference value v_{ref} but only has access to the encrypted reference value ∥v_{ref}∥. In some applications of some private conditional selection protocols, the second entity does have access to the clear value of the reference value v_{ref} and may perform the step of encrypting the reference value v_{ref} with the additively homomorphic encryption algorithm parameterized with the public key of the first entity.

APPLICATION IN EMBODIMENTS OF THE INVENTION. In some embodiments of the invention, a private conditional selection protocol may be used whereby the encrypted test value is an encryption of the inner product of a model parameters vector and the input data vector, i.e., [symbol] vₜₑₛₜ [symbol] ₌ [symbol] _{θ}^{T}x [symbol] . In some embodiments of the invention, a private conditional selection protocol may be used whereby the reference value v)^{,} may be the value of a breakpoint of a segmented function that is used in the model. In some embodiments of the invention, the value of the breakpoint may be known to the server but not to the client. In some embodiments of the invention, a private conditional selection protocol may be used whereby the reference value ∥v₁∥=∥ƒ₁(θ^{T}x)∥. may have the value zero. In some embodiments the target values may be the values of the left and right segment (or compo nent) functions applied to the inner product of a model parameters vector and the input data vector and associated with a breakpoint of a segmented function. For example, in some embodiments the encrypted value of the first target value may be the encrypted value of the left segment function of a breakpoint and the second target value may be the encrypted value of the right segment function of the breakpoint. In some embodiments the first target value may be a first constant. In some embodiments the first target value may be a first constant that has the value zero. In some embodiments the first target value may be a first non-constant function of the inner product of the model parameters vector and the input data vector, i.e., [symbol] v₁ [symbol] = [symbol] ƒ₁(θ^{T}x) [symbol] . In some embodiments the second target value may be a second constant. In some embodiments the second value may be a second constant that has the value zero. In some embodiments the second target value may be a second non-constant function of the inner product of the model parameters vector and the input data vector, i.e., [symbol] v₁ [symbol] = [symbol] ƒ₂(θ^{T}x) [symbol] .

EXAMPLES. The following are examples of private conditional selection protocols. In some embodiments, a method for a first entity and a second entity to perform a private conditional selection protocol for selecting one of a first encrypted target value and a second encrypted target value and providing to the second entity an encrypted result value II? ᵤ)resultli that is homomorphically equivalent to the selected encrypted target value, wherein both the first and second encrypted target values are encrypted with an additively homomorphic encryption algorithm parameterized with a public key of a public-private key pair of the first entity, whereby the second encrypted target value is selected if a test value vₜₜ is larger or equal than a reference value v_{f} and the first encrypted target values [Ivᵢl] is selected otherwise, and whereby the protocol protects the confidentiality or privacy of the test value _{wrest} towards both the first and the second entity, i.e., the encrypted test value ([hest fi) encrypted with the additively homomorphic encryption algorithm parameterized with the public key of the first entity, is known to the second entity, but the protocol provides knowledge of the clear value of the test value, i.e. vₜₜ, to neither the first nor the second entity, may comprise the following steps:
the second entity obtaining the encrypted difference value [symbol] v_{diff} [symbol] of the substraction of the test value and the reference value. [symbol] v_{ref} [symbol] (encrypted with the additively homomorphic encryption algorithm parameterized with the public key of the first entity). If the reference value is known by the second entity to be zero, then this step may consist of the second entity obtaining the encrypted value of the test value and setting the value of the encrypted difference value [symbol] v_{diff} [symbol] to the obtained encrypted value of the test value. In other cases, this step may comprise the second entity obtaining the encrypted values of the test value and the reference value and homomorphically subtracting the encrypted reference value from the encrypted test value. This may comprise the second entity determining or obtaining the value of the reference value (which may for example be a parameter known only to the second entity) and encrypting the determined or obtained reference value with the public key of the first entity, whereby it shares neither the clear reference value nor the encrypted reference value with the first entity, thus ensuring the privacy of the reference value with the first entity.
the first entity and the second entity performing a secret sharing sign determination protocol to determine whether the difference value is larger than or equal to zero, the first entity obtaining a first partial response bit b₁ and the second entity obtaining a second partial response bit b₂ such that the answer to the question whether the difference value is larger than or equal to zero is given by a binary function of the first partial response bit b₁ and the second partial response bit b₂. More in particular, in some embodiments a truly or fully secret sharing sign determination protocol may be used, i.e., a secret sharing sign determination protocol whereby the answer to the question whether the difference value is larger than or equal to zero may be given by the result of applying the exclusive-or operation to the first partial response bit b₁ and the second partial response bit b₂, i.e. In other embodiments, a partially secret sharing sign determination protocol may be used, i.e., a secret sharing sign determination protocol whereby the answer to the question whether the difference value is larger than or equal to zero may be given by the result of applying the the logical AND or the logical OR operation to the first partial response bit b₁ and the second partial response bit b₂, bn Ab₂, or v_{ref}=bₙ A b, A person skilled in the art will appreciate that the two types of partially secret sharing sign determination protocols (i.e., AND or OR type) can be easily converted into each other using the logical equivalence (a∧b) [symbol] ¬(¬a ∨¬b) (i.e., De Morgan's laws).
the first entity and the second entity cooperating, using the first partial response hit b₁ and the second partial response bit b₂, to provide the second entity with an encrypted result value fivᵣₑₛᵤᵢₜfi (encrypted with the additively homomorphic encryption algorithm parameterized with the public key of the first entity), whereby the encrypted result value [symbol] vᵣₑₛᵤₗₜ [symbol] is homomorphically equivalent to the first encrypted target value [v₁] if the difference value [symbol] v_{diff} [symbol] is larger than or equal to zero and is homomorphically equivalent to the second encrypted target value [symbol] v₂ [symbol] otherwise.

The step of the first entity and the second entity cooperating to provide the second entity with the encrypted result value [symbol] vᵣₑₛᵤₗₜ [symbol] may be done as follows.

In some embodiments the first entity may provide the first partial response bit b₁ to the second entity, and the second entity may select the second encrypted target value [symbol] v₂ [symbol] is 1 and select the first encrypted target values [symbol] v₁ [symbol] otherwise. However, in these embodiments, the second entity gets to know the result of the test value and the reference value.

In some embodiments the additively homomorphic encryption algorithm may be semantically secure and the second entity may send the first and second encrypted target values, Qvᵢfl and [lvd] , to the first entity in a particular order determined by the second entity; the first entity may then re-randomize the received encrypted target values to obtain two re-randomized encrypted target values each one of which is homomorphically equivalent to its corresponding original encrypted target value; the first entity may then return the re-randomized encrypted target values in an order that is determined by the value of the first partial response bit b₁ (i.e., the first entity may retain or swap the order of the received encrypted target values depending on the value of the first partial response bit bᵢ); the second entity may then select one of the returned re-randomized encrypted target values as the result of the selection protocol (i.e., the encrypted result value ᵢ HI ᵤresultli) whereby which of the two re-randomized encrypted target values it selects may be determined by the particular order in which the second entity has sent the first and second encrypted target values, to the first entity in combination with the value of the second partial response bit b₂. For example, in some embodiments the second entity may send first the first encrypted target value and then the second encrypted target value to the first entit_{y}; the first entity may return the re-randomized encrypted target values in the same order as the first entity has received the corresponding original encrypted target values from the second entity if b₁=0, and may return the re-randomized encrypted target values in the opposite or swapped order if b₁=1; and the second entity may select as the result of the selection protocol the re-randomized encrypted target value that it first received from the first entity if b₂=0, and select the other re-randomized encrypted target value that it received from the first entity if b₂=1. It will be clear for a person skilled in the art that many variants on this example are possible. For example, the partial response bit values may be replaced by their logical complements, or the second entity may always select the first received re-randomized encrypted target value independently of the value of the second partial response bit b, and instead make the order in which it sends the original first and second encrypted target values dependent of the value of the second partial response bit b₂. In some embodiments, the first entity may re-randomize a received encrypted target value by, for example, decrypting and then re-encrypting that received encrypted target value, or by encrypting the value zero and homomorphically adding this encrypted zero value to the received encrypted target value. In these embodiments, however, the first entity receives the first and second encrypted target values, [symbol] v₁ [symbol] and [symbol] v₁ [symbol] and can therefore obtain the clear values of the target values vᵢ and v₂. In other words, these embodiments don't provide privacy of the target values.

Single masking value. To address the issue of privacy of the target values, the second entity may in some embodiments mask the first and second encrypted target values before sending them to the first entity. The second entity may mask the first and/or second encrypted target values by choosing or obtaining a masking value (preferably in a way such that masking value is unpredictable to the first entity such as by determining the masking value as a random or pseudo-random value), may homomorphically encrypt the masking value (with the said additively homomorphic encryption algorithm parameterized with said public key of the first entity), may homomorphically add the encrypted masking value to the first and second encrypted target values and may then send the masked first and second encrypted target values to the first entity. Subsequently, when the second entity has received the re-randomized masked encrypted target values returned by the first entity, the second entity may unmask at least the selected re-randomized masked encrypted target value by homomorphically subtracting the encrypted masking value from said at least the selected re-randomized masked encrypted target value. However, in these embodiments, the first entity may still obtain the difference of the first and second target values by decrypting and subtracting (or homomophically subtracting and then decrypting) the masked first and second encrypted target values since the subtraction operation will remove the additive mask that both encrypted target values have in common.

Different masking values. To further address the issue of privacy of the target values in a more thorough manner, the second entity may in some embodiments mask the first and second encrypted target values using a first mask to mask the first encrypted target value and a different second mask to mask the second encrypted target value. Since the second entity doesn't know which of the first or second re-randomized and masked encrypted target values has been selected (because of the re-randomization), determining the correct unmasking value to homomorphically subtract from the selected re-randomized and masked encrypted target value is not obvious. In some embodiments, the second entity may obtain the encrypted value of the exclusive disjunction (XOR) of the first and second partial response bits: [symbol] v₁ ⊕b₂ [symbol] _{, and may determine the correct en-crypted value of the unmasking value as a function of the two masking values μ}₁ and μ₂ and the obtained encrypted value of the exclusive disjunction of the first and second partial response bits.

More in particular, the second entity may determine the encrypted value of the unmasking value [symbol] μunmask [symbol] as follows. The second entity may set the value of a base unmasking value _{Pbas,} to the value of the masking value that has been used to mask the encrypted target value that should have been selected in the case that the exclusive disjunction (XOR) of the first and second par tial response bits b₁ b₂ would happen to be 0. The second entity may set the value of an alternative unmasking value pₐᵢₜ to the value of the other masking value, i.e., the masking value that has been used to mask the encrypted target value that should have been selected in the case that the exclusive disjunction (XOR) of the first and second partial response bits b₁ e b₂ would happen to be 1. The second entity may set a difference unmasking value p,_{di ff} to the subtraction of the base unmasking value from the alternative unmasking value, ff =/Jolt Pbase The second entity may then calculate the correct encrypted value of the unmasking value by encrypting the ase unmasking value and homomorphically adding the scalar multiplication of the encrypted value of the exclusive disjunction (XOR) of the first and second partial response bits with the difference unmasking value to the encrypted base unmasking value: [symbol] μᵤₙₘₐₖₑ [symbol] = [symbol] μ_{base} [symbol] [symbol] μ_{diƒƒ}⊙ [symbol] b₁⊕b₂ [symbol] . The second entity may then unmask the selected re-randomized and masked encrypted target value by subtracting the encrypted unmasking value from the elected re-randomized and masked en-crypted target value, and determine the encrypted result value as the unmasked selected encrypted target value.

In some embodiments the second entity may obtain the encrypted value of the exclusive disjunction (XOR) of the first and second partial response bits [16₁ [symbol] 6₂11 as follows. The first entity may homomorphically encrypt its first partial response bit b₁ and send the encrypted first partial response bit Qbᵢfl to the second entity. The second entity verifies the value of its own partial response bit (i.e., the second partial response bit b₂). If the second partial response bit b₂ =0, then the encrypted first partial repsonse bit Qbᵢfl that the second entity received from the first entity is already equal to the encrypted value of the exclusive disjunction of the first and second partial response bits (indeed, in that case [1b₁ e b₂fl =fib₁ e Ofi =fibᵢ), Otherwise, i.e., if b₂ =1, then the second entity may obtain the encrypted value of the exclusive disjunction of the first and second partial response bits by homomorphically encrypting the value 1 and subtracting the encrypted first partial repsonse bit [Ibᵢ fi received from the first entity from this encrypted value: [symbol] b₁⊕b₂ [symbol] = [symbol] l⊕b₁ [symbol] = [symbol] l [symbol] − [symbol] b₁ [symbol] .

Partially secret sharing sign determination protocol. If a partially secret sharing sign determination protocol is used instead of a fully secret sharing sign determination protocol, then it will be clear for a person skilled in the art that for one value of the second partial response bit the value of the first partial response bit is in fact irrelevant and the second entity can autonomously determine which encrypted target value must be selected, and that for the other value of the second partial respose bit essentially the same protocol can be followed as if a fully secret sharing sign determination protocol had been used. In order to not give away the value of the second partial response bit to the first entity, the second entity may in some embodiments in any case carry out the protocol as if a fully secret sharing sign determination protocol had been used, and then decide on the basis of the value of the second partial response bit whether to accept the result of performing this protocol or to reject this result and instead select the encrypted target value that must be selected in the case that the second partial response hit has the value that makes the value of the first partial response hit irrelevant.

3.6 Private minimum and maximum determination protocols

TERMINOLOGY. In the context of this description, a private minimum determination protocol is a protocol between a first and a second entity for selecting one of a first encrypted target value [symbol] v₁ [symbol] and a second encrypted target value [symbol] v₂ [symbol] , wherein both the first and second encrypted target values are encrypted with an additively homomorphic encryption algorithm parameterized with a public key of a public-private key pair of the first entity and wherein the encrypted values of the first and second target values are known to the second entity, whereby the second entity obtains an encrypted value [symbol] vₘᵢₙ [symbol] , that is homomorphically equivalent to the encrypted value of the minimum of the first clear target value v₁ and the second clear target value v₂, i.e. [symbol] vₘᵢₙ [symbol] = [symbol] min(vᵢ, v₂) [symbol] , and whereby:

the protocol protects the confidentiality or privacy of the target values v₁ and v₂ towards both the first and the second entity, i.e., the second entity must know or have access to the encrypted target values [symbol] v₁ [symbol] and [symbol] v₂ [symbol] encrypted with the additively homomorphic encryption algorithm parameterized with the public key of the first entity, but neither the first entity nor the second entity require knowledge of or access to the clear values of the target values, i.e. v₁ and v_{2;} and neither the first nor the second entity get knowledge of or access to the clear values of the target values by performing the protocol;

In the context of this description, a private maximum determination protocol is a protocol between a first and a second entity for selecting one of a first encrypted target value fivᵢfi and a second encrypted target value fiv₂11, wherein both the first and second encrypted target values are encrypted with an additively homomorphic encryption algorithm parameterized with a public key of a public-private key pair of the first entity and wherein the encrypted values of the first and second target values are known to the second entity, whereby the second entity obtains all encrypted value that is homomorphically equivalent to the encrypted value of the maximum of the first clear target value v₁ and the second clear target value v₂, i.e. [symbol] vₘₐₓ [symbol] = [symbol] max(v₁, v₂) [symbol] , and whereby:

the protocol protects the confidentiality or privacy of the target values v₁ and v₂ towards both the first and the second entity, i.e., the second entity must know or have access to the encrypted target values fivᵢfi and fiv₂fi encrypted with the additively homomorphic encryption algorithm parameterized with the public key of the first entity, but neither the first entity nor the second entity require knowledge of or access to the clear values of the target values, i.e. v₁ and v_{2;} and neither the first nor the second entity get knowledge of or access to the clear values of the target values by performing the protocol;

EXAMPLES. In some embodiments, a method for a first entity and a second entity to perform a private minimum determination protocol for selecting one of a first encrypted target value [symbol] v₁ [symbol] and a second encrypted target value [symbol] v₂ [symbol] , wherein both the first and second encrypted target values are encrypted with an additively homomorphic encryption algorithm parameterized with a public key of a public-private key pair of the first entity and wherein the encrypted values of the first and second target values are known to the second entity, whereby the second entity obtains an encrypted minimum value [symbol] vₘᵢₙ [symbol] that is homomorphically equivalent to the encrypted value of the minimum of the first clear target value v₁ and the second clear target value v₂, i.e. [symbol] vₘᵢₙ [symbol] = [symbol] min(v₁, v₂ [symbol] may comprise the first entity and the second entity performing a private conditional selection protocol as described elsewhere in this description wherein:
said first encrypted target value takes on the role of the first encrypted target value of the private conditional selection protocol and
said second encrypted target value takes on the role of the second encrypted target value of the private conditional selection protocol, and wherein
said first encrypted target value [symbol] v₁ [symbol] takes on the role of the test value of the private conditional selection protocol and
said second encrypted target value [symbol] v₂ [symbol] takes on the role of the reference value of the private conditional selection protocol, and wherein
the encrypted result value [symbol] vᵣₑₛᵤₗₜ [symbol] of the private conditional selection protocol is taken as the value for the encrypted minimum value [symbol] vₘᵢₙ [symbol] .

In some embodiments, a method for a first entity and a second entity to perform a private maximum determination protocol for selecting one of a, first encrypted target value [symbol] v₁ [symbol] and a second encrypted target value, wherein both the first and second encrypted target values are encrypted with an additively homomorphic encryption algorithm parameterized with a public key of a public-private key pair of the first entity and wherein the encrypted values of the first and second target valus are known to the second entity, whereby the second entity obtains an encrypted maximum value [1v,ii that is homomorphically equivalent to the encrypted value of the maximum of the first clear target value v₁ and the second clear target value v₂, i.e., may comprise the first entity and the second entity performing a private conditional selection protocol as described elsewhere in this description wherein:
said first encrypted target value [symbol] v₁ [symbol] takes on the role of the first encrypted target value of the private conditional selection protocol and
said second encrypted target value [symbol] v₂ [symbol] takes on the role of the second encrypted target value of the private conditional selection protocol, and wherein
said first encrypted target value [symbol] v₂ [symbol] takes on the role of the test value of the private conditional selection protocol and
said second encrypted target value [symbol] v₁ [symbol] takes on the role of the reference value of the private conditional selection protocol, and wherein
the encrypted result value [symbol] vᵣₑₛᵤₗₜ [symbol] _{of the private conditional selection protocol is taken as the value for the encrypted minimum value} [symbol] ᵥₘₐₓ [symbol] .

### SUMMARY OF THE INVENTION

The presently described invention provides privacy-preserving solutions, methods, protocols and systems for the evaluation of a variety of parameterized data models such as Machine Learning models. An important element of the solutions, methods, protocols and systems of the present invention, is that, although they can be applied to data models in which the result of the evaluation of the data model is a non-linear function of the inputs and the data model parameters, they only make use of additively homomorphic encryption (i.e., homomorphic encryption supporting additions) and don't require the encryption algorithms used to be fully homomorphic (i.e., no requirement for the homomorphic encryption algorithms to support homomorphically multiplying encyphered values). They therefore feature better performance (in terms of communication and/or computational efficiency) than solutions building upon more general privacy-preserving techniques such as fully homomorphic encryption and the likes. Furthermore, they limit the number of interactions between the involved parties.

In some embodiments of the invention a client may have access to gathered data related to a particular task or problem and may have a requirement to obtain an evaluation of the data model on the gathered data as an element for obtaining a solution for the particular task or problem. In some embodiments, the result of the evaluation of the data model may for example be used in a computer-based method for performing a financial risk analysis to determine a financial risk value (such as the risk related to an investment or the credit worthiness of person), or in a computer-based authentication method (for example to determine the probability that a person or entity effectively has the identity that that person or entity claims to have and to take appropriate action such as refusing or granting access to that person or entity to a computer based resource or refusing or accepting an electronic transaction submitted by that person or entity), or in a computer-based method for providing a medical diagnosis.

In some embodiments the data model is at least partially server based, i.e. the client may interact with a data model server to obtain said evaluation of said data model. In some embodiments, at least some of the parameters of the data model are known to the server but not to the client.

GOALS. In some embodiments it is a goal for the method to protect the privacy of the gathered data accessible to the client with respect to the server. I.e., it may be a goal to minimize the information that the server can obtain from any exchange with the client about the values of the gathered data that the client has access to. Additionally, it may be a goal to minimize the information that the server can obtain from any exchange with the client about the obtained evalution, i.e., about the result of evaluating the data model on the gathered data. In some embodiments, at least some of the parameters of the data model are known to the server but not to the client, In some embodiments it is a goal for the method to protect the confidentiality of at least some of the data model parameters that are known to the server but not known to the client. I.e., it may be a goal to minimize the information that the client can obtain from any exchange with the server about the data model parameters known to the server but not known to the client.

### 4.1 Methods

In a first aspect of the invention, a computer-implemented method for evaluating a data model is provided. Some steps of the method may be performed by a client and other steps of the method may be performed by a server, whereby the client may interact with the server to obtain an evaluation of the data model. The data model may be parameterized with a set of parameters which may comprise numeric parameters. The method may be used to obtain an evaluation of the data model on gathered data that are related to a particular task or problem and the obtained evaluation of the data model may be used, e.g., by the client, to obtain a solution for the particular task or problem.

In a first set of embodiments the method may comprise the steps of:
at a client, determining a set of input data representing a set of gathered data that may be related to a particular task and that the client may have access to;
at the client, encrypting the set of input data with an additively homomorphic encryption algorithm using a client public key of a client public-private key pair to obtain a set of encrypted input data;
at the client, sending the set of encrypted input data to a server;
at the server, receiving the set of encrypted input data;
at the server, calculating a set of encrypted output data as a function of the received set of encrypted input data;
at the server, sending the set of encrypted output data to the client;
at the client, receiving the set of encrypted output data;
at the client, decrypting the set of encrypted output data with an additively homomorphic decryption algorithm that matches said additively homomorphic encryption algorithm using a client private key that matches said client public key of said client public-private key pair to obtain said set of output data in the clear;
at the client, determining an evaluation of the data model as a function of the set of decrypted output data (i.e., as a function of the clear output data).

In some embodiments, the method may comprise looping one or more times over the method of the first set of embodiments whereby the input data of the first loop may be determined as described in the description of the first set of embodiments, namely as a function of a set of gathered data, and whereby the input data for each of the following loops may be determined as a function of the result of the previous loop, more in particular as a function of the set of output data obtained in the previous loop, and whereby the evaluation of the data model may be determined as a function of the result of the last loop, more in particular as a function of the set of output data obtained in the previous loop. More in particular, in a second set of embodiments the method may comprise:
performing one or more times a submethod whereby the submethod may comprise the steps of:
at a client, determining a set of input data;
at the client, encrypting the set of input data with an additively homomorphic encryption algorithm using a client public key of a client public-private key pair to obtain a set of encrypted input data;
at the client, sending the set of encrypted input data to a server;
at the server, receiving the set of encrypted input data;
at the server, calculating an set of encrypted output data as a function of the received set of encrypted input data;
at the server, sending the set of encrypted output data to the client;
at the client, receiving the set of encrypted output data;
at the client, decrypting the set of encrypted output data with an additively homomorphic decryption algorithm that matches said additively homomorphic encryption algorithm using a client private key that matches said client public key of said client public-private key pair to obtain said set of output data in the clear;
wherein said determining, at the client, of a set of input data may comprise:
the first time that the submethod is performed during said one or more times performing the submethod, determining the set of input data as a function of a set of gathered data that may be related to a particular problem and that the client may have access to, and may in some embodiments further comprise
every other time or some of the other times that the submethod is performed during said one or more times performing the submethod, determining some or all of the elements of the set of input data as a function of the values of the set of output data obtained the previous time that the submethod is performed during said one or more times performing the submethod;
and wherein the method may further comprise determining an evaluation of the data model as a function of the set of decrypted output data (i.e., clear output data) obtained the last time that the submethod is performed.

In some embodiments of the first and second set of embodiments, determining the set of input data as a function of a set of gathered data may comprise extracting a set of features (which may for example be represented by a feature vector) from the gathered data and determning the set of input data as a function of the extracted set of features.

In some embodiments, the method may comprise any of the methods of the previous embodiments, wherein determining the set of input data may comprise representing the elements of the set of input data as integers.

In some embodiments, the method may comprise any of the methods of the previous embodiments or any of the methods described elsewhere in this description, wherein the additively homomorphic encryption and decryption algorithms are semantically secure. In some embodiments, the additively homomorphic encryption and decryption algorithms are probabilistic. For example, in some embodiments the additively homomorphic encryption and decryption algorithms comprise the Paillier cryptosystem. In some embodiments, the additively homomorphic encryption algorithm may comprise mapping the value of the data element that is being encrypted (i.e., a message m) to the value of that data element subjected to a modulo operation with a certain modulus [symbol] (i.e., the message m may be mapped on m mod [symbol] ), wherein the value of the modulus [symbol] may be a parameter of the method.

In some embodiments, the method may comprise any of the methods of the previous embodiments, wherein said encrypting the set of input data with an additively homomorphic encryption algorithm may comprise encrypting the set of input data with said additively homomorphic encryption algorithm parameterized by a public key of the client and said decrypting the set of encrypted output data with said additively homomorphic decryption algorithm may comprise decrypting the set of encrypted output data with said additively homomorphic decryption algorithm parameterized by a private key of the client that matches said public key of the client.

In some embodiments, the method may comprise any of the methods of the previous embodiments wherein said calculating said set of encrypted output data as a function of the received set of encrypted input data may comprise calculating the set of encrypted output data as a function of the encrypted elements of the input data wherein said function may be parameterized by a set of data model parameters.

In some embodiments, the method may comprise any of the methods of the previous embodiments wherein said calculating said set of encrypted output data as a function of the received set of encrypted input data may comprise calculating each element of the set of encrypted output data as a linear combination of the encrypted elements of the input data. In some embodiments the coefficients of the various encrypted elements of the input data of the various linear combinations for each element of the set of encrypted output data may differ from one element of the set of encrypted output data to another element of the set of encrypted output data. In some embodiments of the second set of embodiments, the coefficients of the various encrypted elements of the input data of the various linear combinations for each element of the set of encrypted output data may differ from one round of performing the submethod to another round of performing the submethod. In some embodiments at least some of the coefficients of the various linear combinations for each element of the set of encrypted output data may be parameters of a data model the values of which may be known to the server but not to the client, In some embodiments the coefficients are represented as integer values. In some embodiments any, some or all of the various linear combinations of the encrypted elements of the input data may be calculated as a homomorphic addition of the scalar multiplication of each encrypted element of the input data with its corresponding integer coefficient. In some embodiments the value of the scalar multiplication of a particular encrypted element of the input data with its corresponding integer coefficient may be equal to the value of the repeated homomorphic addition of that particular element of the input data to itself whereby the number of times that the particular element of the input data is hoomorphically added to itself is indicated by the value of its corresponding integer coefficient. In other words, in some embodiments the value of the scalar multiplication of a particular encrypted element of the input data with its corresponding integer coefficient may be equal to the value of a homomorphic summation whereby the value of each of the terms of the summation are equal to the value of that particular encrypted element of the input data and whereby the number of terms of that summation is equal to the value of the corresponding integer coefficient.

In some embodiments, the method may comprise any of the methods of the previou embodiments or any of the other methods described elsewhere in this description wherein the method is combined with differential privacy techniques. In particular, in sonic embodiments the method comprises the client adding noise to the input data prior to sending the set of encrypted input data to a server, and/or the server adding noise to the aforementioned coefficients or data model parameters prior to or during the server calculating a set of encrypted output data as a function of the received set of encrypted input data. In some embodiments, the noise may be gaussian. For example, in some embodiments, the client may add noise terms (which may be gaussian noise) to the values of some or all of the elements of the set of gathered data (prior to determining the set of input data representing the set of gathered data), or to some or all of the elements of the set of input data (prior to encrypting the set of input data), or to some or all of the elements of the set of encrypted input data (after encrypting the set of input data and prior to sending the set of, now modified, encrypted input data to the server). For example, in some embodiments the server may add noise terms (which may be gaussian noise) to some or all of the aforementioned coefficients or data :model parameters, or to some or all elements of the set of encrypted output data (thus modifying the set of encrypted output data calculated in the step of calculating an set of encrypted output data as a function of the received set of encrypted input data and before sending the set of modified encrypted output data to the client).

In some embodiments, the method may comprise any of the methods of the previous embodiments wherein determining an evaluation of the data model as a function of the set of decrypted output data may comprise calculating at least one result value as a non-linear function of the decrypted output data. In some embodiments the non-linear function may comprise an injective function such as for example the sigmoid function. In some embodiments the non-linear function may comprise a non-injective function such as for example a sign function or a step function such as the Heaviside step function. In some embodiments the non-linear function may comprise a function used in the field of artificial neural networks as an activation function in the units of an artificial neural network. In some embodiments the non-linear function may comprise the Rectifier, ReLu or ramp function ƒ(x)=max(O, x). In some embodiments the non-linear function may comprise the hyperbolic tangent function ƒ(x=tan h(x), or the softplus or SmoothReLu function ƒ(x)=log(1+exp (x)), or the Leaky ReLu or parametric ReLu function ƒ(x)=max(a·x, x) wherein a is a parameter that has a value that is (much) smaller than 1. In some embodiments the non-linear function may comprise a piecewise linear function.

GENERAL METHOD. Some embodiments of the invention comprise a method for evaluating a data model parameterized for a set of gathered data, wherein
the data model is parameterized by a set of data model parameters associated with a server and not known to a client;
the client has a set of input data not known to the server, wherein said set of input data may comprise a set of data representing the set of gathered data such as a set of features extracted from the gathered data; wherein
a first entity A has a first vector vₐ and a first public-private key pair that comprises a first public key and first private key for parameterizing a first pair of matching additively homomorphic encryption and decryption algorithms, and a second entity B has a second vector v_{b},
at least the coordinates (or vector components) of said second vector v_{b} may be represented as integers, and wherein also the coordinates (or vector components) of said first vector vₐ may be represented as integers;
and wherein
either said first entity is said client and said first vector vₐ represents said set of input data, and said second entity is said server and said second vector v_{b} may represent said set of data, model parameters,
or said second entity is said client and said second vector v_{b} represents said set of input data, and said first entity is said server and said first vector vₐ may represent said set of data model parameters;
   and wherein the method may comprise the steps of:
the first entity encrypting the first vector vₐ with the first encryption algorithm (i.e., the additively homomorphic encryption algorithm of the first pair of matching additively homomorphic encryption and decryption algorithm) using the first public key (i.e., the public key of the first public-private key pair for parameterizing the first pair of matching additively homomorphic encryption and decryption algorithms);
the second entity receiving the encrypted first vector vₐ;
the second entity homomorphically calculating a value, further referred to as the encrypted inner product value of the inner product of the second vector v_{b} and the encrypted first vector ∥vₐ∥ or shortly as the encrypted inner product value or encrypted inner product, such that the encrypted inner product value is homomorphically equivalent with an encryption with the first encryption algorithm and the first public key of the value of the inner product of the second vector v_{b} and the first vector vₐ. In particular, in sone embodiments the second entity homomorphically calculating the encrypted inner product value may comprise the second entity homomorphically calculating the encrypted inner product value as the homomorphic addition of all the homomorphic scalar multiplications of each encrypted coordinate of the encrypted first vector ∥vₐ∥ with the corresponding coordinate of the second vector v_{b};
the second entity obtaining a first encrypted intermediate value as a function of the encrypted inner product value;

In some embodiments, the method may further comprise the steps of:
the client obtaining a second intermediate value having the same value as the first encrypted intermediate value when decrypted with the first decryption algorithm (i.e., the additively homomorphic decryption algorithm of the first pair of matching additively homomorphic encryption and decryption algorithm) using said first private key (i.e., the private key of the first public-private key pair for parameterizing the first pair of matching additively homomorphic encryption and decryption algorithms); and
the client using the second intermediate value to determine an evaluation result value (representing the result of evaluating the data model) as a function of said second intermediate value. In some embodiments the client may set the evaluation result value to the value of the second intermediate value (i.e., said function is the identity function). In some embodiments the client may determine the evaluation result by applying a client function to the value of the second intermediate value. In some embodiments, said client function may comprise a non-linear function. In some embodiments, said client function may comprise an injective non-linear function, such as any of the injective functions mentioned elsewhere in this description.

In some embodiments, the first entity may be the client and the second entity may be the server, and the step of the client obtaining the second intermediate value may comprise the steps of:
the second entity sending the first encrypted intermediate value to the first entity, and the first entity receiving the first encrypted intermediate value from the second entity;
the first entity determining the second intermediate value by decrypting the received first encrypted intermediate value with the first decryption algorithm (i.e., the additively homomorphic decryption algorithm of the first pair of matching additively homomorphic encryption and decryption algorithm) using the first private key (i.e., the private key of the first public-private key pair for parameterizing the first pair of matching additively homomorphic encryption and decryption algorithms), wherein the first entity may set the second intermediate value to the value of the decrypted received first encrypted intermediate value;

In some embodiments, the second entity may be the client and the first entity may be the server, and the step of the client obtaining the second intermediate value may comprise the steps of:
the second entity (i.e., the client) choosing a masking value, the value of which is preferably unpredictable to the first entity, encrypting the masking value with the first encryption algorithm using the first public key, masking the first encrypted intermediate value by homomorphically adding the encrypted masking value to the first encrypted intermediate value, sending the masked first encrypted intermediate value to the first entity;
the first entity receiving the masked first encrypted intermediate value from the second entity, calculating a third intermediate value by decrypting the received masked first encrypted intermediate value (i.e., the third intermediate value is equal to the sum of the unencrypted first intermediate value and the unencrypted masking value), and returning the third intermediate value resulting from this decrypting to the second entity;
the second entity (i.e., the client) determining the second intermediate value by subtracting the masking value from the received third intermediate value.

In some embodiments, the second entity obtaining a first encrypted intermediate value as a function of the encrypted inner product value may comprise the second entity obtaining the first encrypted intermediate value as an encrypted value that is homomorphically equivalent (for the first encryption algorithm and the first public key) to an encrypted function of the clear inner product value.

In some embodiments, the second entity obtaining a first encrypted intermediate value as a function of the encrypted inner product value may comprise the second entity obtaining the first encrypted intermediate value as an encrypted value that is homomorphically equivalent (for the first encryption algorithm and the first public key) to a homomorphic sum, the terms of which comprise at least once said encrypted inner product value and further comprise zero, one or more other terms. In some embodiments, the second entity obtaining a first encrypted intermediate value as a function of the encrypted inner product value may comprise the second entity obtaining the first encrypted intermediate value as an encrypted value that is homomorphically equivalent (for the first encryption algorithm and the first public key) to a linear function of the clear inner product value. In some embodiments, the second entity may obtain the first encrypted intermediate value as a linear function of the encrypted inner product value whereby said linear function may be defined by a slope factor and an offset term and whereby said slope factor and offset term may be represented as integers. In some embodiments, the second entity may calculate the first encrypted intermediate value by homomorphically adding said offset term to a homomorphic scalar multiplication of the encrypted inner product value with said slope factor. In some embodiments, the step of the second entity obtaining a first encrypted intermediate value as a function of the encrypted inner product value may comprise the second entity obtaining the encrypted evalution value of an encrypted linear function of the inner product value, for example, by obtaining a slope factor and an encrypted offset term of the encrypted linear function and homomorphically adding said encrypted offset term to a homomorphic scalar multiplication of the encrypted inner product value with said slope factor. In some embodiments, the second entity may know the unencrypted value of the offset term and may obtain the encrypted offset term by encrypting said unencrypted value of the offset term. In other embodiments, the second entity may receive the encrypted offset term from the first entity. In some embodiments the second entity obtaining a first encrypted intermediate value as a function of the encrypted inner product value may comprise the second entity setting the value of the first encrypted intermediate value to the obtained encrypted evalution value. In other embodiments, the step of the second entity obtaining a first encrypted intermediate value as a function of the encrypted inner product value may further comprise the second entity using the obtained encrypted evalution value as an input for obtaining a second encrypted evalution value of a second encrypted function of the inner product, and using that second encrypted evalution value for obtaining the first encrypted intermediate value.

In some embodiments, the second entity obtaining a first encrypted intermediate value as a function of the encrypted inner product value may comprise the second entity obtaining the first encrypted intermediate value as an encrypted value that is homomorphically equivalent (for the first encryption algorithm and the first public key) to the encryption (with the first encryption algorithm and the first public key) of a piece-wise linear function of the clear inner product value. In some embodiments, the second entity may obtain the first encrypted intermediate value by performing a protocol for the private evaluation of a piece-wise linear function of an encrypted value wherein said encrypted value is the encrypted inner product value. In some embodiments, said protocol for the private evaluation of a piece-wise linear function of an encrypted value may comprise any of the protocols for the private evaluation of a piece-wise linear function of an encrypted value described elsewhere in this description.

In some embodiments, the second entity obtaining a first encrypted intermediate value as a function of the encrypted inner product value may comprise the second entity obtaining the encrypted evalution value of an encrypted broken function of the inner product value (wherein the terminology ‘encrypted evalution value of an encrypted function of an input value’ designates an encrypted value that is homomorphically equivalent to an encryption of a value obtained by the evolution of said function of said input value). In some embodiments the second entity obtaining a first encrypted intermediate value as a function of the encrypted inner product value may comprise the second entity setting the value of the first encrypted intermediate value to the obtained encrypted evalution value. In other embodiments, the step of the second entity obtaining a first encrypted intermediate value as a function of the encrypted inner product value may further comprise the second entity using the obtained encrypted evalution value as an input for obtaining a second encrypted evalution value of a second encrypted function of the inner product, and using that second encrypted evolution value for obtaining the first encrypted intermediate value, e.g., by setting the first encrypted intermediate value to that second encrypted evalution value of for obtaing yet another third encrypted evalution value of another third encrypted function of the inner product.

In some embodiments the encrypted broken function of the inner product value may be an encrypted broken function with one breakpoint and a first (left) segment or component function and a second (right) segment or component function, and the second entity may obtain the encrypted evaluation value of this encrypted broken function of the inner product value by: the second entity obtaining a first encrypted segment value that is homomorphically equivalent to the encrypted evaluation of the first segment function of the inner product, the second entity obtaining a second encrypted segment value that is homomorphically equivalent to the encrypted evaluation of the second segment function of the inner product, and the second entity obtaining an encrypted breakpoint value that is homomorphically equivalent to an encryption of said breakpoint; and the second entity and the first entity performing a private conditional selection protocol to select the second encrypted segment value if the inner product of said first vector and said second vector is positive and to select the first encrypted segment value otherwise.

In some embodiments the encrypted broken function of the inner product value may be an encrypted broken function with multiple breakpoints and multiple corresponding segment or component functions, and the second entity may obtain the encrypted evaluation value of this encrypted broken function of the inner product value by performing for all the breakpoints, one after the other in ascending order, the steps of:—the second entity obtaining a left encrypted input value and a right encrypted input value,—the second entity and the first entity performing a private conditional selection protocol to select the second encrypted segment value if the inner product of said first vector and said second vector is positive and to select the first encrypted segment value otherwise, and setting an auxiliary result value for that breakpoint to the result of said performing said private conditional selection protocol,—wherein the second entity obtains the right encrypted input value by setting the right encrypted input value to an encrypted evaluation value of the encrypted segment function to the right of that breakpoint,—and wherein the second entity obtains the left encrypted input value by setting for the first (i.e., leftmost) breakpoint the left encrypted input value to an encrypted evaluation value of the encrypted segment function to the right of that first breakpoint and by setting for all other breakpoints the left encrypted input value to the auxiliary result value obtained for the previous breakpoint;—and thereafter the second entity setting the encrypted evaluation value to the auxiliary result value that the second entity obtained for the last (i.e., largest) breakpoint.

NON-LINEAR REGRESSION. In some embodiments, said homomorphic sum may be equal to said encrypted inner product value; and the step of the client using the second intermediate value to determine an evaluation result value such that the evaluation result value is a non-linear function of the value of the inner product of said first vector and said second vector, may comprise the client calculating the evaluation result value by applying a non-linear function to the second intermediate value.

If said homomorphic sum is equal to said encrypted inner product value then this implies that the homomorphic sum only comprises one term, namely once the encrypted inner product value, and no other terms. It also means that the first encrypted intermediate value is equal to the encrypted inner product value and hence that the value of the second intermediate value is equal to the value of the inner product.

Evaluation of non-linear functions without giving the client or the server access to the value of the inner product. In some embodiments, the evaluation result value is a non-linear function of the value of the inner product of said first vector and said second vector and neither the client nor the server gets to know the actual value of the inner product of said first vector and said second vector.

SVM CLASSIFICATION—SIGN FUNCTION OF THE INNER PRODUCT. In some embodiments, the client may determine the evaluation result value such that the evaluation result value is a function of the sign of the value of the inner product of said first vector and said second vector, wherein neither the client nor the server gets to know the actual value of the inner product of said first vector and said second vector. In some embodiments, the evaluation result value may be a non-linear function of the value of the inner product of said first vector and said second vector, said non-linear function may be a function of the sign of the value of the inner product of said first vector and said second vector, and neither the client nor the server gets to know the actual value of the inner product of said first vector and said second vector. In sone embodiments, the client may get to know the sign of the value of the inner product of said first vector and said second vector and may determine the evaluation result value as a function of said sign of the value of the inner product of said first vector and said second vector.

In some embodiments, the step of the second entity obtaining a first encrypted intermediate value may comprise the second entity obtaining an encrypted value that is homomorphically equivalent to the encrypted value of one of two different classification values if the value of the inner product of said first vector and said second vector is positive and that is homomorphically equivalent to the encrypted value of the other one of said two different classification values otherwise (i.e., if the value of the inner product of said first vector and said second vector is not positive). For example, in some embodiments the classification value for the case wherein the inner product of said first vector and said second vector is positive may be ‘1’ and the other classification value may be ‘−1’.

In some embodiments, the first entity and the second entity may perform one of the private sign determination protocols described elsewhere in this description (in particular one of the protocols described in Section 3.4) to determine the sign of the value of the inner product of said first vector and said second vector, i.e., to determine whether the value of the inner product of said first vector and said second vector is larger than or equal to zero. More particularly, in some embodiments the step of the second entity obtaining a first encrypted intermediate value as a function of the encrypted inner product value may comprise said performing by the first entity and the second entity of said one of the private sign determination protocols. In some embodiments, said private sign determination protocols may comprise a secret sharing sign determination protocol described elsewhere in this description. In some embodiments, said secret sharing sign determination protocols may advantageously comprise a fully secret sharing sign determination protocol described elsewhere in this description. In some embodiments, said secret sharing sign determination protocols may comprise a partially secret sharing sign determination protocol described elsewhere in this description.

In some embodiments, the step of the second entity obtaining a first encrypted intermediate value may comprise the second entity obtaining a first encrypted classification value and a second encrypted classification values (that is not homomorphically equivalent to the first encrypted classification value), and the second entity and the first entity may perform a private conditional selection protocol to select the second encrypted classification value if the inner product of said first vector and said second vector is positive and to select the first encrypted classification value otherwise. In some embodiments, said private conditional selection protocol may comprise one of the protocols of Section 3.5), preferably one that provides privacy of the result of the comparison towards the second entity in case the second entity is the server or one that provides privacy of the result of the comparison towards the first entity in case the first entity is the server, whereby the first encrypted target value may be set to the first encrypted classification value, the second encrypted target value may be set to the second encrypted classification value, the encrypted test value may be set to the encrypted inner product of the first vector and the second vector, and the reference value may be set to zero, and whereby the second entity may set the first encrypted intermediate value to the encrypted result value that results from said performing by the first and second entities of the private conditional selection protocol.

USING A PRIVATE COMPARISON PROTOCOL. In some embodiments, the method may further comprise the first entity and the second entity performing a private comparison protocol to compare a first comparison value known to the first entity with a second comparison value known to the second entity to establish the sign of the inner product of said first vector and said second vector, or to establish whether the value of the inner product is higher or lower than a certain threshold value (such as for example a breakpoint of a broken function).

USING THE DGK+ PROTOCOL FOR PRIVATE COMPARISON. In some embodiments said private comparison protocol may comprise the DGK+ private comparison protocol or a variant thereof. The additively homomorphic encryption and decryption algorithms used when performing the DGK+ protocol may or may not comprise or be comprised in the additively homomorphic encryption and decryption algorithms performed in the other steps of the method. In particular, in some embodiments the same additively homomorphic encryption and decryption algorithms that are used for encrypting the first or second vector and decrypting a sum that comprises as a term the encrypted value of the inner product of the first vector and the second vector, may also be used in steps of the DGK+ protocol. In other embodiments the additively homomorphic encryption and decryption algorithms used in the DGK+ algorithm may be different from the additively homomorphic encryption and decryption algorithms that are used for encrypting the first or second vector and decrypting a sum that comprises as a term the encrypted value of the inner product of the first vector and the second vector. In some embodiments, when the first and second entity perform said private comparison protocol, the first entity may take on the role of the DGK+ client and the second entity may take on the role of the DGK+ server. In other embodiments, when the first and second entity perform said private comparison protocol, the first entity may take on the role of the DGK+ server and the second entity may take on the role of the DGK+ client. This is independent of which of the first and second entities correspond to the client and server of the method for evaluating the data model. It should be noted that the terminology ‘DGK+ client’ an ‘DGK+ server’ are not synonymous to the terminology ‘client’ and ‘server’ used in the overall description of the method for evaluating the data model. I.e., in some embodiments the entity that takes on the role of the DGK+ client may correspond to the client of the method for evaluating the data model and the entity that takes on the role of the DGK+ server may correspond to the server of the method for evaluating the data model, but in other embodiments the entity that takes on the role of the DGK+ client may correspond to the server of the method for evaluating the data, model and the entity that takes on the role of the DGK+ server may correspond to the client of the method for evaluating the data model. In some embodiments, the method may further comprise:
the second entity selecting, preferably randomly or in an unpredictable way for the first entity, an additive masking value;
the second entity encrypting the additive masking value with the first encryption algorithm using the first public key;
the second entity calculating the first encrypted intermediate value by homomorphically adding the encrypted additive masking value to said encrypted inner product value;
the first entity setting a first comparison value to the second intermediate value (i.e., the value of the decrypted received first encrypted intermediate value, which in turn is the decrypted value of the sum of the encrypted additive masking value and the encrypted inner product value, which means that the second intermediate value equals the masked inner product, i.e., the sum of the inner product and the additive masking value);
the second entity setting a second comparison value to the additive masking value;
the first entity and the second entity using a private comparison protocol to establish whether the first comparison value is smaller than the second comparison value;
the first entity obtaining the result of establishing whether the first comparison value is smaller than the second comparison value;
the first entity determines the sign of the inner product of said first vector and said second vector as negative if said result of said performing said private comparison protocol indicates that said first comparison value (i.e., the masked inner product) is smaller than said second comparison value (i.e., the additive masking value).

In some embodiments the masking value may be selected from a range of values that is minimally as large as the range of all possible values for the inner product of said first vector and said second vector. In some embodiments the masking value may be selected from a range of values that is much larger than the range of all possible values for the inner product of said first vector and said second vector. In some embodiments the masking value may be selected from a range of values that is at least a factor 2′ larger than the range of all possible values for the inner product of said first vector and said second vector, wherein κ is a security parameter. In some embodiments κ is 40; in some embodiments κ is 64; in some embodiments is 80; in some embodiments κ is 128. In some embodiments the masking value may be a positive value that is larger than the absolute value of the most negative possible value for the inner product of said first vector and said second vector.

In some embodiments the first entity and the second entity using a private comparison protocol to establish whether the first comparison value is smaller than the second comparison value may comprise the first entity and the second entity performing the private comparison protocol to compare the first comparison value to the second comparison value.

In some embodiments the first entity and the second entity using a private comparison protocol to establish whether the first comparison value is smaller than the second comparison value may comprise the first entity setting a third comparison value to the first comparison value modulo D and the second entity setting a fourth comparison value to the second comparison value modulo D, performing the private comparison protocol to compare the third comparison value to the fourth comparison value, and determining whether the first comparison value is smaller than the second comparison value by combining the outcome of said performing the private comparison protocol to compare the third comparison value to the fourth comparison value with the least significant bit of the result of the integer division of the first comparison value by D and the least significant bit of the result of the integer division of the second comparison value by D, wherein D is a positive value that at least as large as the largest absolute value for any possible value for the inner product of said first vector and said second vector. In some embodiments D may be a power of 2.

USING A HEURISTIC PROTOCOL FOR PRIVATE COMPARISON. In some embodiments, the method may further comprise;
the second entity selecting, preferably randomly or in an unpredictable way for the first entity, a positive non-zero scaling masking value;
the second entity selecting, preferably randomly or in an unpredictable way for the first entity, an additive masking value wherein the absolute value of the additive masking value is smaller than the absolute value of the scaling masking value;
the second entity encrypting the additive masking value with the first encryption algorithm using the first public key;
the second entity calculating the first encrypted intermediate value by calculating the scalar multiplication of the encrypted inner product value with said scaling masking value and homomorphically adding the encrypted additive masking value to said scalar multiplication of the encrypted inner product value with said scaling masking value;
the first entity determining the sign of the inner product of said first vector and said second vector as the sign of the second intermediate value (i.e., the value of the decrypted received first encrypted intermediate value, which in turn is the decrypted value of the sum of the encrypted additive masking value and the scalar multiplication of the encrypted inner product value with the scaling masking value, which means that the second intermediate value equals the masked inner product, i.e., the sum of the inner product scaled with the scaling masking value and the additive masking value).

In a variant of the previously described embodiments, the method may further comprise:
the second entity selecting, preferably randomly or in an unpredictable way for the first entity, a signed non-zero scaling masking value and retaining the sign of the selected scaling masking value;
the second entity selecting, preferably randomly or in an unpredictable way for the first entity, an additive masking value wherein the absolute value of the additive masking value is smaller than the absolute value of the scaling masking value;
the second entity encrypting the additive masking value with the first encryption algorithm using the first public key;
the second entity calculating the first encrypted intermediate value by homomorphically calculating the scalar multiplication of the encrypted inner product value with said scaling masking value and homomorphically adding the encrypted additive masking value to said scalar multiplication of the encrypted inner product value with said scaling masking value;
the first entity determining the sign of the second intermediate value (i.e., the value of the decrypted received first encrypted intermediate value, which in turn is the decrypted value of the sum of the encrypted additive masking value and the scalar multiplication of the encrypted inner product value with the scaling masking value, which means that the second intermediate value equals the masked inner product, i.e., the sum of the inner product scaled with the scaling masking value and the additive masking value);
the first entity and the second entity determining together the sign of the sign of the inner product of said first vector and said second vector by combining the sign of the second intermediate value determined by the first entity with the sign of the scaling masking value retained by the second entity.

The methods of these variants are an example of embodiments wherein a secret sharing private comparison protocol is used to compare a first comparison value known to the first entity with a second comparison value known to the second entity to establish the sign of the inner product of said first vector and said second vector.

PIECEWISE LINEAR FUNCTIONS. In what follows a broken function g(t) with a breakpoint b is a function that call be defined as: g(t):g(t)=ƒ₁(t) if t<b; and g(t)=ƒ₂(t) if b≤t . The function ƒ₁(t) may be referred to as the first component (or segment) function of the broken function g(t) and the function ƒ₂(t) may be referred to as the second component (or segment) function of the broken function g(t).

A particular example of a broken function is a continuous or discontinuous piecewise linear function with a single breakpoint b: g(t) : g(t)=fᵢ(t)=m₁ t+qᵢ if t<b and g(t)=(t)=m₂, t+q₂ if b≤t.

The sign function sign(t) sign(t)=1 if t<0; sign(t)=1 if 0≤t; is an example of a discontinuous piecewise linear function with a single breakpoint wherein b=0, raᵢ=m₂=0, qᵢ=1; q₂=1.

The step function step(t) : step(t)=0 if t<0; step(t)=1 if 0-<t; is an example of a discontinuous piecewise linear function with a single breakpoint wherein b=0, m.=m₂ =0, qᵢ=0, q₂=1.

The ReLU function ReLU(t) : ReLU(t)=0 if t <0; ReLU(t)=t if 0 <t ; is an example of a continuous piecewise linear function with a single breakpoint wherein h=0, rrn=0, m₂ =1, qᵢ=0.

A generalized ReLU function, is a ReLU function that is scaled by a factor a, to which an offset c and a step function scaled by a factor d is added, whereby the breakpoint is shifted to b, and that may be mirrored : GeneratizedRetu(t)=a ReLU(s (t b))+d step(s (t b))+c (wherein the value of s is either 1 or −1).

A generalized ReLU function GeneralizedRelu(t) =a ReLU(s (t b)) +d step(s (t h)) +c is an example of a continuous or discontinuous piecewise linear function with a single breakpoint b.

A continuous or discontinous piecewise linear function with n breakpoints b₁, . . . , bᵢ, . . . , bₙ with b₁< . . . <bᵢ<. . . <bₙ) os a function g(t) that can be defined as g(t):g(t)=9m₀·t+q₀) if t<b₁; g(t)=mᵢ·t+qᵢ) if bᵢ≤t<bᵢ₊₁.

In the context of this description, the terminology ‘simple piecewise linear function’ is used to refer to a piecewise linear function with no or exactly one breakpoint. A linear function is a simple piecewise linear function with no break-points. A generalized ReLU function is an example of a simple piecewise linear function with a single breakpoint.

Without loss of generality, the convention has been used in the above definitions to include the breakpoint itself in the domain interval to the right of the breakpoint. A person skilled in the art will readily realize that this convention is arbitrary and that a breakpoint might as well be included in the domain interval to the left of that breakpoint with trivial changes to the protocols of the described invention.

PRIVATE EVALUATION OF A NON-LINEAR BROKEN FUNCTION OF THE INNER PRODUCT OF TWO VECTORS. In an aspect of the invention, a method for private evaluation of a non-linear broken function of the inner product of a first vector with a second vector is provided. In some embodiments the method is performed by a first and a second entity wherein a first entity knows the value of the first vector while the other entity does not know that value and doesn't need to know that value for performing the method, and the second entity knows the value of the second vector while the first entity does not know the value of that second vector and doesn't need to know the value of that second vector for performing the method, and whereby the second entity obtains the encrypted evaluation value of the non-linear broken function of the inner product of the first vector and the second vector, which encrypted evaluation value can only be decrypted by the first entity.

In some embodiments the method may comprise a method for obtaining an additively homomorphically encrypted evaluation result the value of which corresponds to the additively homomorphically encrypted evaluation value of a broken function with breakpoint b of the inner product of a first vector with a second vector.

In some embodiments, the method may comprise a method wherein;
a, first entity has said first vector and a first public-private key pair for parameterizing a first pair of matching additively homomorphic encryption and decryption algorithms, and
a second entity has said second vector; and wherein the method may comprise the steps of:
the second entity obtaining the encrypted first vector, for example, by:
the first entity encrypting the first vector with the first encryption algorithm (i.e., the additively homomorphic encryption algorithm of the first pair of matching additively homomorphic encryption and decryption algorithm) using the first public key (i.e., the public key of the first public-private key pair for parameterizing the first pair of matching additively homomorphic encryption and decryption algorithms), and
the second entity receiving the encrypted first vector;
the second entity homomorphically calculating an encrypted inner product value of the inner product of the second vector and the encrypted first vector, such that the encrypted inner product value equals the value of the encryption with the first encryption algorithm and the first public key of the value of the inner product of the second vector and the first vector;
the second entity obtaining an encrypted first component function value wherein said encrypted first component function value is equal to the value of the encryption with the first encryption algorithm and the first public key of the value of the first component function of the broken function for the value of the inner product of the second vector and the first vector;
the second entity obtaining an encrypted second component function value wherein said encrypted second component function value is equal to the value of the encryption with the first encryption algorithm and the first public key of the value of the second component function of the broken function for the value of the inner product of the second vector and the first vector;
the second entity masking the obtained encrypted first component function value;
the second entity masking the obtained encrypted second component function value;
the second entity sending the masked encrypted first component function value and the masked encrypted second component function value to the first entity;
the first entity receiving the masked encrypted first component function value and the masked encrypted second component function value from the second entity;
the first entity re-randomizing the received masked encrypted first component function value and masked encrypted second component function value;
the first entity and the second entity using a private comparison protocol to determine whether the value of the inner product of the second vector and the first vector is larger than or equal to the breakpoint b of the broken function, wherein the first entity obtains a first binary value b1 and the second entity obtains a second binary value b1 (i.e., such that a binary value that is equal to the exclusive or-ing of said first binary value hi and said second binary value b2 corresponds to whether the value of the inner product of the second vector and the first vector is larger than or equal to the breakpoint b of the broken function;
the first entity assembling the re-randomized masked encrypted first component function value and re-randomized masked encrypted second component function value into an ordered pair, wherein the order of appearance of the re-randomized masked encrypted first component function value and re-randomized masked encrypted second component function value in said ordered pair is determined by said first binary value bl (i.e., wherein the choice of setting the first component of the ordered pair to either the re-randomized masked encrypted first component function value or the re-randomized masked encrypted second component function value and setting the second component of the ordered pair to the other one of the re-randomized masked encrypted first component function value and the re-randomized masked encrypted second component function value, is determined by the first binary value b1).
the first entity sending the ordered pair to the second entity;
the second entity receiving the ordered pair of the first entity;
the second entity selecting one of the components of the received ordered pair (which contains the re-randomized masked encrypted first component function value and the re-randomized masked encrypted second component function value in an order that is not known to the second entity if the second entity doesn't know the value of the first binary value bl), wherein which of the components the second entity selects depends on the second binary value b2.
the second entity unmasking the selected component of the ordered pair to obtain an unmasked selected component of the ordered pair (which is either the re-randomized masked encrypted first component function value and the re-randomized masked encrypted second component function value, depending on both the first binary value bl and the second binary value b2, and thus depending on whether the value of the inner product of the second vector and the first vector is larger than or equal to the breakpoint b);
the second entity determining the additively homomorphically encrypted evaluation result as said unmasked selected component of the ordered pair (which means that the additively homomorphically encrypted evaluation result is set to either the encrypted first component function value or the encrypted second component function value, again depending on whether the value of the inner product of the second vector and the first vector is larger than or equal to the breakpoint b).

HYPERPARAMETERS. In some embodiments the breakpoint of the broken function may be a hyperparameter of a data model, known to a server but not to a client.

PIECEWISE LINEAR BROKEN FUNCTION WITH A SINGLE BREAKPOINT. In some embodiments the first component function of the broken function may be a linear function with a first slope factor m₁ and a first offset term q₁ f₁(t)=m₁t+q₁); and the second component function of the broken function may be a linear function with a second slope factor and a second offset term q₂ f₂(t)=m₂·t+q₂) (wherein m₁ and m₂ may be different or qᵢ and q₂ may be different). In some embodiments the breakpoint, any combination of the first and second slope factors and the first and second offset terms may be hyperparameters of a data model, known to a server but not to a client. Furthermore, in some embodiments,
the step of the second entity obtaining an encrypted first component function value may comprise the second entity calculating the encrypted first component function value; for example, by:
the second entity encrypting the first offset term qᵢ with the first (additive homomorphic) encryption algorithm using the first public key;
the second entity additively homomorphically calculating the encrypted first component function value by homomorphically calculating the scalar multiplication of the encrypted inner product value with said first slope factor m₁ and homomorphically adding the encrypted first offset term q₁ to said scalar multiplication of the encrypted inner product value with said first slope factor m₁; and
the step of the second entity obtaining an encrypted second component function value may comprise the second entity calculating the encrypted second component function value, for example, by;
the second entity encrypting the second offset term q, with the first (additive homomorphic) encryption algorithm using the first public key;
the second entity additively homomorphically calculating the encrypted second component function value by homomorphically calculating the scalar multiplication of the encrypted inner product value with said second slope factor m₂ and homomorphically adding the encrypted second offset term q₂ to said scalar multiplication of the encrypted inner product value with said second slope factor m₂;

In other embodiments, the calculation of the encrypted first component function value and/or the encrypted second component function value may be done by the first entity or partly by the first entity and partly by the second entity. For example, in some embodiments the first entity may apply the (linear) first component function to the first vector and/or may also apply the (linear) second component function to the (components of) the first vector (either before or after the encryption of the first vector by the first entity with the first encryption algorithm using the first public key) and send the resulting encrypted linearly transformed first vector(s) to the second entity.

MASKING. In some embodiments, the second entity masking the obtained en-crypted first component function value may comprise the second entity choosing a firs masking value μ₂, encrypting the first masking value μ₁ with the first (additive homomorphic) encryption algorithm using the first public key, and homomorphically adding the encrypted masking value μ₁ to the obtained encrypted first component function value.

In some embodiments, the second entity masking the obtained encrypted second component function value may comprise the second entity choosing a second masking value μ₂, encrypting the second masking value μ₂ with the first (additive homomorphic) encryption algorithm using the first public key, and homomorphically adding the encrypted masking value to the obtained encrypted second component function value.

In some embodiments, the first masking value μ₁ and the second masking value μ₂, may have the same value. In some embodiments, the first masking value μ₁ or the second masking value μ₂ may be zero.

RE-RANDOMIZING. In some embodiments, the first entity re-randomizing the received masked encrypted first component function value and masked encrypted second component function value may comprise:
the first entity choosing a first randomization value f1, encrypting the first randomization value r I with the first (additive homomorphic) encryption al gorithm using the first public key, and homomorphically adding the encrypted first randomization value r1 to the received masked encrypted first component function value; and
the first entity choosing a second randomization value r2, encrypting the second randomization value r2 with the first (additive homomorphic) encryption algorithm using the first public key, and homomorphically adding the encrypted second randomization value r2 to the received masked encrypted second component function value.

In some embodiments, the first entity may choose the first randomization value r1 and the second randomization value r2 such that they have the same value. In some embodiments the first entity may choose the first randomization value r1 and the second randomization value r2 such that they have the same value but may nevertheless encrypt both of the first randomization value rl and the second randomization value r2 separately. In some embodiments, the first entity may choose the first randomization value r I and the second randomization value r2 such the one or both of them have the value zero.

In embodiments wherein one or both of the first randomization value r I and the second randomization value r2 are chosen to be different from zero, the method may further comprise an additional de-randomization step wherein the second entity de-randomizes the unmasked selected component of the ordered pair, and wherein the step of the second entity determining the additively homomorphically encrypted evaluation result as said unmasked selected component of the ordered pair is replaced by the step of the second entity determining the additively homomorphically encrypted evaluation result as said de-randomized unmasked selected component of the ordered pair. If the first randomization value rl and the second randomization value r2 have been chosen such that they have the same value, the first entity may send the encrypted value of the randomization value to the second entity and the second entity de-randomizing the unmasked selected component of the ordered pair may comprise the second entity homomorphically subtracting the encrypted value of the randomization value from the (unmasked) selected component of the ordered pair. If the first randomization value r1 and the second randomization value r2 have been chosen such that they have different values, the first entity may determine a de-randomization value, encrypt the de-randomization value with the first (additive homomorphic) encryption algorithm using the first public key, send the encrypted de-randomization value to the second entity, and the second entity may homomorphically add the encrypted de-randomization value to the (unmasked) selected component of the ordered pair. To determine the de-randomization value, the second entity may encrypt the second binary value b2 with the first (additive homomorphic) encryption algorithm using the first public key and send the encrypted second binary value b2 to the first entity and the first entity may use the received encrypted second binary value b2 and its own first binary value bl in a way that is fully analogous to the way that the second entity determines an encrypted unmasking value using its own binary value b2 and the encrypted first binary value bl that it receives from the first entity as described further in this description.

In some embodiments de-randomizing may be done before unmasking. It should further be noted that de-randomization doesn't actually undo the randomization effect of the homomorphic addition of the encrypted randomization values (which is due to the probabilistic nature of the additive homomorphic encryption algorithm), but undoes the additional effect of causing an offset to be added if the randomization value is different from zero.

PRIVATE COMPARISON PROTOCOL. In some embodiments, the first entity and the second entity using a private comparison protocol to determine whether the value of the inner product of the second vector and the first vector is larger than or equal to the breakpoint b of the broken function may comprise the first entity and the second entity using the private comparison protocol to determine whether the value of the inner product of the second vector and the first vector minus the value of the breakpoint b of the broken function is larger than or equal to zero. In some embodiments the entity knowing the value of the breakpoint b may encrypt that value with the first (additive homomorphic) encryption algorithm using the first public key and provide that encrypted value of the breakpoint b to the entity calculating the encrypted value of the inner product of the second vector and the first vector minus the value of the breakpoint b.

In some embodiments, the private comparison protocol preferably comprises a secret-sharing private comparison protocol. In some embodiments the first binary value bl is not known to the second entity. In some embodiments the second binary value b1 is not known to the first entity. In some embodiments the first binary value b1 is not known to the second entity and the second binary value bl is not known to the first entity. In some embodiments the private comparison protocol may comprise the DGK+ protocol. In some embodiments the first entity may take on the role of the DGK+ client and the second entity may take on the role of the DGK+ server in performing the DGK+ protocol. In other embodiments, the second entity may take on the role of the DGK+ client and the first entity may take on the role of the DGK+ server in performing the DGK+ protocol. In some embodiments, the private comparison protocol may comprise the heuristic protocol described earlier in this description.

In some embodiments, the DGK+ protocol or the heuristic protocol may be used in a secret sharing way to determine whether the value of the inner product of the second vector and the first vector is larger than or equal to the breakpoint b, and may be used in essentially the same way as described elsewhere in this description (for determining the sign of the inner product of the second vector and the first vector or of the inner product of the input vector and the data model parameter vector) but by substituting the encrypted value of the inner product by the encrypted value of the inner product minus the value of the breakpoint b.

RE-ORDERING AND SELECTING. In some embodiments, the steps of the first entity assembling the re-randomized masked encrypted first component function value and re-randomized masked encrypted second component function value into an ordered pair (more specifically determining the order in the ordered pair) and the second entity selecting one of the components of the received ordered pair, may happen as follows. In some embodiments, the first entity may set the first component of the ordered pair to the re-randomized masked encrypted first component function value and the second component of the ordered pair to the re-randomized masked encrypted second component function value if the first binary value b1 has the value 1, and the first entity may set the first component of the ordered pair to the re-randomized masked encrypted second component function value and the second component of the ordered pair to the re-randomized masked encrypted first component function value if the first binary value b1 has the value zero. When selecting one of the components of the received ordered pair, the second entity may then select the first component of the ordered pair if the second binary value b2 has the value 1 and may select the second component of the ordered pair if the second binary value b2 has the value zero.

UNMASKING. In some embodiments, the step of the second entity unmasking the selected component of the ordered pair to obtain an unmasked selected component of the ordered pair may comprise the second entity obtaining an encrypted unmasking value as a function of the first masking value and the second masking value, and homomorphically adding the encrypted unmasking value to the selected component of the ordered pair.

In some embodiments, the first masking value and the second masking value may be the same, and the second entity may determine an unmasking value as the inverse (for the addition operation) of the (first and second) masking value, and the encrypted unmasking value may be obtained by the second entity encrypting the unmasking value with the first (additive homomorphic) encryption algorithm using the first public key.

In other embodiments, determining the encrypted unmasking value may comprise:
the first entity encrypting its first binary value bl with the first (additive homomorphic) encryption algorithm using the first public key and sending the encrypted first binary value bl to the second entity;
the second entity receiving the encrypted first binary value b1
the second entity calculating the encrypted unmasking value as a function of the received encrypted first binary value bl_{;} its own second binary value b2, the first masking value and the second masking value.

The second entity may calculate the encrypted unmasking value as the inverse (for the addition operation) of the homomorphic sum of the first masking value encrypted with the first encryption algorithm using the first public key and an encrypted selection value that is equal to the encryption (with the first encryption algorithm using the first public key) of the exclusive oring of the first binary value bl and the second binary value b2 homomorphically scalarly multiplied with the difference between the second masking value and the first masking value. The second entity may calculate the encrypted selection value as follows: if the second binary value b2 is zero then the second entity may set the encrypted selection value to the received encrypted first binary value; if the second binary value b2 has the value 1 then the second entity may encrypt its second binary value b2 with the first (additive homomorphic) encryption algorithm using the first public key, determine the inverse (for the addition) of the encrypted second binary value b2, and set the encrypted selection value to the homomorphic addition of the received encrypted first binary value with the inverse of the encrypted second binary value b2.

PRIVATE EVALUATION OF A PIECEWISE LINEAR FUNCTION OF THE INNER PRODUCT OF TWO VECTORS. A continuous or discontinuous piecewise linear function with Ti breakpoints (b₁, . . . , bᵢ, . . . , bₙ with b₁<. . . <bᵢ<. . . <bₙ) can be defined as the sum of a number (e.g., n+1) of simple piecewise linear functions, such as for example a number (e.g., n+1) of generalized ReLu functions. For example, the piecewise linear function with n breakpoints g(t) defined as g(t): g(t)=(m₀trtgₒ) if t<b₁; g(t)=(mᵢtrt gᵢ) if bᵢ G i <bᵢ₊₁; g(t)=(in,trtg,) if b G t, can be written as the sum of n ±1 simple piecewise linear functions SPLᵢ: g(t)=₀ SPLᵢ(t) , wherein these T1 ±1 simple piecewise linear functions SPLᵢ(t) may be defined as follows, for i =0 SPL₀(t)=(mₒ t qₒ), and for 1 n: SPLᵢ(t) =0 if t <bᵢ and SPLᵢ(t)=((mᵢmᵢ₋ᵢ) t+(qᵢ qᵢ₋ᵢ)) if bᵢ t

This means that the additively homomorphically encrypted evaluation result of a piecewise linear function with n breakpoints of the inner product can therefore be obtained by the additively homomorphic summation of the additively homomorphic encrypted evaluation results of each of these simple piecewise linear functions (e.g., generalized ReLu functions) making up the piecewise linear function with n breakpoints.

A method for the private evaluation of a (continuous or discontinuous) piece- wise linear function of the inner product of a first vector and a second vector wherein said piecewise linear function is equivalent to the sum of a particular plurality of simple piecewise linear functions (e.g., generalized ReLU functions) may comprise:
performing for each of said particular plurality of simple piecewise linear functions (or generalized ReLU functions) one of the above described methods for the private evaluation of a non-linear broken function of the inner product of said first vector with a second vector (wherein the non-linear broken function is taken to be each of said particular plurality of simple piecewise linear functions or generalized ReLU functions in turn) to obtain an encrypted evaluation value of the inner product of said first vector with a second vector;
obtaining an encrypted evaluation value of said piecewise linear function of the inner product of the first vector and the second vector by setting said encrypted evaluation value to the sum of all said encrypted evaluation values of the inner product of said first vector with a second vector for each of said particular plurality of simple piecewise linear functions (or generalized ReLU functions),

PRIVATE EVALUATION OF A NON-LINEAR BROKEN FUNCTION OF THE INNER PRODUCT OF TWO VECTORS FOR THE PRIVATE EVALUATION OF A DATA MODEL.

In some embodiments, a method for the private evaluation of a data model on a set of gathered data related to a particular problem may comprise performing one of the methods for private evaluation of a non-linear broken function,

In some embodiments, said first entity is a client and said first vector is an input vector, and said second entity is a server and said second vector is a data model parameter vector.

In other embodiments, said second entity is said client and said second vector is the input vector, and said first entity is the server and said first vector is the data model parameter vector.

In some embodiments the input vector is known to the client but not to the server and the data model parameter is know to the server but not to the client.

In some embodiments, the input vector represents a set of feature data that have been extracted from the set of gathered data related to a particular problem.

In some embodiments the parameter vector represents a set of parameters of the data model.

In some embodiments the method for the private evaluation of a data model on a set of gathered data related to a particular problem may further comprise
said first entity obtaining said encrypted evaluation result (which is the result of said performing one of the methods for private evaluation of a non-linear broken function);
the first entity decrypting said encrypted evaluation result;
the client obtaining said decrypted evaluation result;
the client determining a data model evaluation result as a function of said decrypted evaluation result.

In some embodiments the non-linear broken function is a function, such as a piecewise linear function, that approximates a more general non-linear function (such as the arctan(t) function or the softplus function).

PRIVATE EVALUATION OF A NON-LINEAR BROKEN FUNCTION OF THE INNER PRODUCT OF TWO VECTORS FOR THE PRIVATE EVALUATION OF A NEURAL NETWORK. In an aspect of the invention, a method is provided for the private evaluation of a data model that comprises a neural network. In some embodiments, the neural network may be a feedforward network with one or more layers, whereby the inputs of each neuron of the first layer are comprised in the set of input data elements to the neural network as a whole, the inputs of each neuron of each following layer are comprised in the set of the outputs of all neurons of all previous layers, and the outputs of the neural network as a whole are part of the set of all neurons of all layers.

In some embodiments, the method may comprise performing by a client and a server the steps of:
the client encrypting each of the input data, elements to the overall network;
the client sending said encrypted input data elements to the server;
the server receiving said encrypted input data elements from the client;
the client and the server performing for each layer of the overall network, starting with the first layer and continuing with each following layer until the last layer, the steps of:
determining for each neuron an encrypted output value by performing for said each neuron one of the methods for private evaluation of a non-linear broken function (wherein said non-linear broken function is the activation function or an approximation thereof -of the neuron), wherein:
the first entity is the client, the second entity is the server, the second vector may comprise the weights and threshold of the neuron;
the first vector represents the inputs to the neuron;
the step of the second entity obtaining the encrypted first vector comprises setting each component of the encrypted first vector to (an appropriate) one of the received encrypted input data elements or to an encrypted output value of (an appropriate) one of the neurons of one of the previous layers;
the server sets the encrypted output value to said encrypted evaluation result (i.e., the result of performing the one of the methods for private evaluation of a non-linear broken function);
the server setting each of the encrypted output value(s) of the neural network as a whole to an encrypted output of (an appropriate) one of the neurons of one of the layers of the neural network.

In some embodiments, the method may further comprise the server sending the encrypted output value(s) of the neural network as a whole to the client, the client receiving the encrypted output value(s) of the neural network as a whole from the server, and the client decrypting the received encrypted output value(s) of the neural network as a whole.

In some embodiments, the method may further comprise the client determining a data model evaluation result as a function of the decrypted output value(s) of the neural network as a whole.

In some embodiments, the non-linear broken function may comprise a (continuous or discontinuous) piecewise linear function, and the parameters of the piecewise linear function (i.e., the number of sections, the values of the slope factors, the offset term and the breakpoint position for each section) may be hyperparameters of the neural network.

In some embodiments, the non-linear broken function may be the same for all neurons of the neural network. In other embodiments the non-linear broken function may differ for each neuron of the neural network. For some embodiments, the non-linear broken function may be the same for all neurons of a given layer of the neural network but may differ from one layer to another,

In some embodiments the client may comprise one or more computing de vices, such as a computer, a PC (personal computer) or a smartphone. In some embodiments the server may comprise one or more computing devices, such as for example a server computer or a computer in a data center or a cloud computing resource. In some embodiments the client may comprise at least one computing device that is not comprised in the server. In some embodiments at least one of the components of the client is physically or functionally different from any of the components of the server. In some embodiments the client computing devices are physically different from the server computing devices and the client computing devices may be connected to the server computing devices for example by a computer network such as a LAN, a WAN or the internet. In some embodiments the client may comprise one or more client software components, such as client software agents o applications or libraries, executed by one or more computing devices. In some embodiments the server may comprise one or more server software components, such as software agents or applications or libraries, executed by one or more computing devices. In some embodiments the client software components and the server software components may be executed by different computing devices. In some embodiments some client software components may be executed by the same computing devices but in another computing environment as some of the server software components. In some embodiments all of the client components are denied access to at last some of the data accessible to at least some of the server components, such as for example data model parameters, which may comprise the aforementioned scalar multiplication coefficients, used by the server to in said calculating said set of encrypted output data as a function of the received set of encrypted input data. In sonic embodiments all of the server components are denied access to at last some of the data accessible to at least some of the client components,

### 4.2 Systems

In a second aspect of the invention, a system for evaluating a data model is provided. The system may comprise a client and a server. The client may be adapted to perform any, sonic or all of the client steps of any of the methods described elsewhere in this description. The server may be adapted to perform any, some or all of the server steps of any of the methods described elsewhere in this description.

In some embodiments of aspects of the invention, the client may comprise one or more client computing devices, such as a computer, a laptop, a smart-phone. The client computing devices comprised in the client may comprise a data processing component and a memory component. The memory component may be adapted to permanently or temporarily store data such as gathered data related to a particular task, one or more private and/or public cryptographic keys and intermediate calculation results, and/or instructions to be executed by the data processing component such as instructions to perform various steps of one or more of the various methods described elsewhere in this description, in particular the steps to be performed by a client. The data processing component may be adapted to perform the instructions stored on the memory component. One or more of the client computing devices may further comprise a computer network interface, such as for example an ethernet card or a WWI interface or a mobile data network interface, to connect the one or more client devices to a computer network such as for example the internet. The one or more client computing devices may be adapted to exchange data over said computer network with for example a server.

In some embodiments of aspects of the invention, the server may comprise one or more server computing devices, such as a server computer, for example a computer in a data center. The server computing devices comprised in the server may comprise a data processing component and a memory component. The memory component may be adapted to permanently or temporarily store data such as the parameters of a Machine Learning model, one or more private and/or public cryptographic keys and intermediate calculation results, and/or instructions to be executed by the data processing component such as instructions to perform various steps of one or more of the various methods described elsewhere in this description, in particular the steps to be performed by a server. The data processing component may be adapted to perform the instructions stored on the memory component. One or more of the server computing devices may further comprise a computer network interface, such as for example an ethernet card, to connect the one or more client devices to a computer network such as for example the internet. The one or more server computing devices may be adapted to exchange data over said computer network with for example a client.

### 4.3 Software

In a third aspect of the invention a first volatile or non-volatile computer-readable medium is provided containing one or more client series of instructions, such as client software components, which when executed by a client device cause the client device to perform any, some or all of the client steps of any of the methods described elsewhere in this description.

In a fourth aspect of the invention a second volatile or non-volatile computer-readable medium is provided containing one or more server series of instructions, such as server software components, which when executed by a server device cause the server device to perform any, some or all of the server steps of any of the methods described elsewhere in this description.

In some embodiments, the first and/or second computer-readable media may comprise a RAM memory of a computer or a non-volatile memory of computer such as a harddisk or a USB memory stick or a CD-ROM or a DVD-ROM.

### 4.4 Additional Methods

In fifth aspect of the invention, a first computer-implemented method for a privacy-preserving evaluation of a data model is provided. In some embodiments the data model may be a Machine Learning model. In some embodiments, the data model may be a Machine Learning regression model. In a first set of embodiments of this first method, the method may comprise the following steps. A client may gather data related to a particular task, The client may extract a feature vector from the gathered data, wherein extracting the feature vector may comprise representing the components of the feature vector as integers, The client may encrypt the feature vector by encrypting each of the components of the extracted feature vector using an additively homomorphic encryption algorithm that may be parameterized with a public key of the client. The client may send the encrypted feature vector to a server, The server may store a set of Machine Learning model parameters. ‘The server may receive the encrypted feature vector. The server may compute the encrypted value of the inner product of a model parameter vector and the feature vector. The components of the model parameter vector may consist of the values of the Machine Learning model parameters comprised in the set of Machine Learning model parameters. The components of the model parameter vector may be represented as integers. The server may compute the encrypted value of the inner product of the model parameter vector and the feature vector by homomorphically computing the inner product of the model parameter vector with the received encrypted feature vector. Homomorphically computing the inner product of the model parameter vector with the received encrypted feature vector may comprise or consist of computing for each component of the encrypted feature vector a term value by repeatedly homomorphically adding said each component of the encrypted feature vector to itself as many times as indicated by the value of the corresponding component of the model parameter vector and then homomorphically adding together the resulting term values of all components of the encrypted feature vector. The server may determine a server result as a server function of the resulting computed encrypted value of the inner product of the model parameter vector and the feature vector. The server may send the server result to the client. The client may receive the server result that has been determined by the server. The client may decrypt the server result that it has received. The client may decrypt the received server result using an additively homomorphic decryption algorithm that matches said additively homomorphic encryption algorithm. The client may decrypt the received server result using said additively homomorphic decryption algorithm parameterized with a private key of the client that may match said public key of the client. The client may compute a Machine Learning model result by evaluating a client function of the decrypted received server result.

In a second set of embodiments, the method may comprise any of the methods of the first set of embodiments, wherein the client function of the decrypted received server result may comprise a linear function. In some embodiments the linear function may comprise the identity mapping function.

In a third set of embodiments, the method may comprise any of the methods of the first set of embodiments, wherein the client function of the decrypted received server result may comprise a non-linear function. In some embodiments the non-linear function may comprise a piece-wise linear function. In some embodiments the non-linear function may comprise a step function. In some embodiments the non-linear function may comprise a polynomial function. In some embodiments the non-linear function may comprise a transcendent function. In some embodiments the non-linear function may comprise a sigmoid function such as the logistic function. In some embodiments the non-linear function may comprise a hyperbolic function such as the hyperbolic tangent. In some embodiments the non-linear function may comprise an inverse trigonometric function such as the arctangent function. In some embodiments the non-linear function may comprise the softsign function, or the softplus function or the leaky ReLU function. In some embodiments the non-linear function may be an injective function. In other embodiments the non-linear function may be a non-injective function.

In a fourth set of embodiments, the method may comprise any of the methods of the first to third sets of embodiments wherein the server determining the server result as a server function of the resulting computed encrypted value of the inner product of the feature vector and the model parameter vector may comprise the server setting the value of the server result to the value of the resulting computed encrypted value of the inner product of the feature vector and the model parameter vector.

In a fifth set of embodiments, the method may comprise any of the methods of the first to third sets of embodiments wherein the server determining the server result as a server function of the resulting computed encrypted value of the inner product of the feature vector and the model parameter vector may comprise the server determining the value of a noise term, homomorphically adding said value of the noise term to said computed encrypted value of the inner product of the feature vector and the model parameter vector, and setting the value of the server result to the homomorphic addition of said value of the noise term and said computed encrypted value of the inner product of the feature vector and the model parameter vector. In some embodiments the server may determine the value of the noise term in an unpredictable way. In some embodiments the server may determine the value of the noise term as a random number in a given range. In some embodiments said given range may be a function of said Machine Learning model parameters. In some embodiments the value of the noise term may be a function of said Machine Learning model parameters. In some embodiments the value of the noise term may be a function of said machine learning model parameters and a random data element. In some embodiments of the invention, these same techniques to add noise may also be used with any of the other methods described elsewhere in this description.

In a sixth set of embodiments, the method may comprise any of the methods of the first to fifth sets of embodiments wherein the client extracting the feature vector may comprise the client extracting an intermediate vector from the gathered data and determining the components of the feature vector as a function of the components of the intermediate vector. In some embodiments determining the components of the feature vector as a function of the components of the intermediate vector may comprise calculating at least one component of the feature vector as a product of a number of components of the intermediate vector. In some embodiments at least one component of the intermediate vector may appear multiple times as a factor in said product.

In a seventh set of embodiments, the method may comprise any of the methods of the first to sixth sets of embodiments wherein the additively homomorphic encryption and decryption algorithm may comprise Paillier's cryptosystem.

In a sixth aspect of the invention, a second method for a privacy-preserving evaluation of a Machine Learning regression model is provided. In a first set of embodiments of the second method, the method may comprise the following steps. A client may gather data related to a particular task. The client may extract a feature vector from the gathered data, wherein extracting the feature vector may comprise representing the components of the feature vector as integers. A server may store a set of Machine Learning model parameters. The server may encrypt a model parameter vector, The components of the model parameter vector may consist of the values of the Machine Learning model parameters comprised in the set of Machine Learning model parameters. The components of the model parameter vector may be represented as integers. The server may encrypt the model parameter vector by encrypting each of the components of the model parameter vector using an additively homomorphic encryption algorithm that may be parameterized with a public key of the server. The server may publish the encrypted model parameter vector to the client. The server may make the encrypted model parameter vector available to the client. The client may obtain the encrypted model parameter vector, The server may for example send the encrypted model parameter vector to the client, and the client may for example receive the encrypted model parameter vector from the server. The client may compute the encrypted value of the inner product of the model parameter vector and the feature vector. The client may compute the encrypted value of the inner product of the model parameter vector and the feature vector by homomorphically computing the inner product of the received encrypted model parameter vector with the feature vector. Homomorphically computing the inner product of the received encrypted model parameter vector with the feature vector may comprise or consist of computing for each component of the encrypted model parameter vector a term value by repeatedly homomorphically adding said each component of the encrypted model parameter vector to itself as many times as indicated by the value of the corresponding component of the feature vector and then homomorphically adding together the resulting term values of all components of the encrypted model parameter vector. The client may determine an encrypted masked client result as a function of the computed encrypted value of the inner product of the model parameter vector and the feature vector. The client may send the encrypted masked client result to the server. The server may receive the encrypted masked client result that has been determined by the client. The server may decrypt the encrypted masked client result that it has received. The server may decrypt the received encrypted masked client result using an additively homomorphic decryption algorithm that matches said additively homomorphic encryption algorithm. The server may decrypt the received encrypted masked client result using said additively homomorphic decryption algorithm parameterized with a private key of the server that may match said public key of the server. The server may determine a masked server result as a server function of the result of the server decrypting the received encrypted masked client result. The server may send the masked server result to the client. The client may receive the masked server result that has been determined by the server. The client may determine an unmasked client result as a function of the received masked server result. The client may compute a Machine Learning model result by evaluating a client function of the determined unmasked client result.

In a second set of embodiments, the method may comprise any of the methods of the first set of embodiments, wherein the client function of the determined unmasked server result may comprise a linear function. In some embodiments the linear function may comprise the identity mapping function.

In a third set of embodiments, the method may comprise any of the methods of the first set of embodiments, wherein the client function of the determined unmasked server result may comprise a non-linear function. In some embodiments the non-linear function may comprise a piece-wise linear function. In some embodiments the non-linear function may comprise a step function. In some embodiments the non-linear function may comprise a polynomial function. In some embodiments the non-linear function may comprise a transcendent function. In some ebodiments the non-linear function may comprise a sigmoid function such as the logistic function. In some embodiments the non-linear function may comprise a hyperbolic function such as the hyperbolic tangent. In some embodiments the non-linear function may comprise an inverse trigonometric function such as the arctangent function. In some emodiments the non-linear function may comprise the softsign function, or the softplus function or the leaky ReLU function. In some embodiments the non-linear function may be an injective function. In other embodiments the non-linear function may be a non-injective function.

In a fourth set of embodiments, the method may comprise any of the methods of the first to third sets of embodiments wherein the server determining the masked server result as a server function of the result of the server decrypting the received encrypted masked client result may comprise the server setting the value of the masked server result to the value of the result of the server decrypting the received encrypted masked client result.

In a fifth set of embodiments, the method may comprise any of the methods of the first to third sets of embodiments wherein the server determining the masked server result as a server function of the result of the server decrypting the received encrypted masked client result may comprise the server determining the value of a noise term, homomorphically adding said value of the noise term to said result of the server decrypting the received encrypted masked client result, and setting the value of the masked server result to the homomorphic addition of said value of the noise term and said result of the server decrypting the received encrypted masked client result. In some embodiments the server may determine the value of the noise term in an unpredictable way. In some embodiments the server may determine the value of the noise term as a random number in a given range. In some embodiments said given range may be a function of said Machine Learning model parameters. In some embodiments the value of the noise term may be a function of said Machine Learning model parameters. In some embodiments the value of the noise term may be a function of said Machine Learning model parameters and a random data element.

In a sixth set of embodiments, the method may comprise any of the meth ods of the first to fifth sets of embodiments wherein the client extracting the feature vector may comprise the client extracting an intermediate vector from the gathered data and determining the components of the feature vector as a function of the components of the intermediate vector. In some embodiments determining the components of the feature vector as a function of the components of the intermediate vector may comprise calculating at least one component of the feature vector as a product of a number of components of the intermediate vector. In some embodiments at least one component of the intermediate vector may appear multiple times as a factor in said product.

In a seventh set of embodiments, the method may comprise any of the methods of the first to sixth sets of embodiments wherein the additively homomorphic encryption and decryption algorithm may comprise Paillier's cryptosystem.

In an eighth set of embodimets, the method may comprise any of the methods of the first to seventh sets of embodiments whereby the client determining the encrypted masked client result as a function of the computed encrypted value of the inner product of the model parameter vector and the feature vector may comprise the client setting the value of the masked client result to the value of the computed encrypted value of the inner product of the model parameter vec tor and the feature vector; and the client determining the unmasked client result as a function of the received masked server result may comprise the client setting the value of the unmasked client result to the value of the received masked server.

In a ninth set of embodiments, the method may comprise any of the methods of the first to seventh sets of embodiments whereby the client determining the encrypted masked client result as a function of the computed encrypted value of the inner product of the model parameter vector and the feature vector may comprise the client determining a masking value, the client encrypting the determined masking value by using said additively homomorphic encryption algorithm parameterized with said public key of the server, and the client setting the value of the masked client result to the result of homomorphically adding the encrypted masking value to said computed encrypted value of the inner product of the model parameter vector and the feature vector; and whereby the client determining the unmasked client result as a function of the received masked server result may comprise the client setting the value of the unmasked client result to the result of subtracting said determined masking value from the received masked server result. In some embodiments the client may determine the masking value in an unpredictable mariner (i.e., unpredictable to other parties than the client). In some embodiments the client may determine the masking value in a random or pseudo-random manner. In some embodiments the client may determine the masking value by picking the masking value, preferably uniformly, at random from the domain of said additively homomorphic encryption algorithm (i.e., from the set of integers forming the clear message space [symbol] .

### 5 Basic Protocols of Privacy-Preserving Inference

Particular embodiments of the above described methods for privacy-preserving evaluation of a Machine Learning data model are described in more detail in the following paragraphs.

### Basic Protocols of Privacy-Preserving Inference

Particular embodiments of the above described methods for privacy-preserving evaluation of a Machine Learning regression model are described in more detail in the following paragraphs.

In this section, we present three families of protocols for private inference. They aim to satisfy the ideal requirements given in the introduction while keeping the number of exchanges to a bare minimum. Interestingly, they only make use of additively homomorphic encryption (rather than requiring fully homomorphic encryption).

We keep the general model presented in the introduction, but now work with integers only. The client holds x=(1, x₁, . . . x_{d})^{T} E [symbol] , a private feature vector, and the server possesses a trained Machine Learning data model given by its parameter vector θ=(0₀, . . . , 0_{d})^{T} [symbol] , or in the case of feed-forward neural networks a set of matrices made of such vectors. At the end of the protocol, the client obtains the value of g(θ^{T}x) for some function g and learns nothing else; the server learns nothing. To make the protocols easier to read, for a real-valued function g, we abuse notation and write g(t) instead of g(t/2^{P}) for an integer t representing the real number t/2^{P}; see Section 3.1. We also make the distinction between the encryption algorithm [symbol] using the client's public key and the encryption algorithm [symbol] using the server's public key and stress that, not only the keys themselves are different, but that the encryption algorithms using respectively the client's public key and the server's public key could also be different from one another. We use [symbol] and [symbol] for the respective corresponding decryption algorithms.

### 5.1 Duality

We further remark that in the protocols described in the following paragraphs the evaluation of the data model with input data x and data model parameter set θ is a function of the inner product θ of the input data vector x and the data model parameter vector θ. The role of the input data vector and the data model parameter vector in this inner product is symmetric, i.e., there is a duality between the input data vector and the data model parameter vector. This means that for each protocol whereby the client encrypts its input data with an additively homomorphic encryption algorithm under its client public key and sends the encrypted input data to the server whereupon the server then calculates the encrypted value of the inner product of its data model parameter vector with the (encrypted) input data vector received from the client, it is straightforward to formulate a corresponding dual model that comprises essentially the same steps but whereby the role of the client and the server are reversed in that it is in this corresponding dual protocol the server that encrypts its data model parameters with an additively homomorphic encryption algorithm under its server public key and sends the encrypted parameters to the client whereupon the client then calculates the encrypted value of the inner product of the (encrypted) data model parameter vector received from the server with its input data vector. Of course, the reverse is, mutatis mutandis, also true. This duality principle is valid for all the protocols described in the following paragraphs, such that whenever a particular protocol is described or disclosed in this description, the corresponding dual protocol is automatically also at least implicitly disclosed even if it is not necessarily explicitly described.

### 5.2 Private Regression

Private Linear Regression. As seen in Section 2.2, linear regression produces estimates using the identity map for g:y=0^{T}x. Since 0^{T}x==o1x₁is linear, given an encryption Ixfi of x, the value of [θ′x] can be homomorphically evaluated, in a provable way [10].

Therefore, the client encrypts its feature vector x under its public key with an additively homomorphic encryption algorithm ∥·∥, and sends ∥x∥ to the server. Using θ, the server then computes ∥θ^{T}x∥ and returns it to the client. Finally, the client uses its private key to decrypt ∥θ^{T}x∥=∥ŷ∥ and gets the output y. This is only requires one round of communication.

Private Logistic Regression. Things get more complicated for logistic regression. At first sight, it seems counter-intuitive that additively homomorphic encryption could suffice to evaluate a logistic regression model over encrypted data. After all, the sigmoid function, a(t), is non-linear (see Section 2.1).

A key inventive insight of the inventors in this case is that the sigmoid function is injective:

$$σ ( {t}_{1} ) = σ ( {t}_{2} ) ⟹ {t}_{1} = {t}_{2} .$$

This means that the client does not learn more about the model B from t:=O^{T}x than it can learn from fᵢ:=a(t) since the value of t can be recovered from y using t=a⁻¹W=1n(1 Consequently, rather than returning an encryption of the prediction y, we let the server return an encryption of t, without any security loss in doing so.

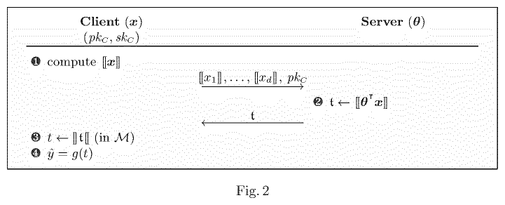

A First ‘Core’ Protocol for Private Regression. The protocol we propose for privacy-preserving linear or logistic regression is detailed in FIG. 2. Let (pk,, sk,) denote the client's matching pair of public encryption key/private decryption key for an additively homomorphic encryption scheme [symbol] . We use the notation of Section 3,2. If B is an upper bound on the inner product (in absolute value), the message space [symbol] ={[14/2], [ [symbol] /21 1} should be such that [symbol] 2B -H 1.
1. In a first step, the client encrypts its feature vector x E [symbol] ^{d}+¹ under its public key pk_{c} and gets [symbol] x [symbol] =(∥x_{b}∥, ∥x₁∥, . . . ∥x_{d}∥). The ciphertext ∥x∥ along with the client's public key are sent to the server.'
2. In a second step, from its model θ, the server computes an encryption of the inner product over encrypted data as:

$$t = 〚 {θ}^{T} x 〛 = 〚 {θ}_{0} 〛 {θ}_{j} ⊙ 〚 {x}_{j} 〛 .$$

The server returns t to the client.
3. In a third step, the client uses its private decryption key sk_{C} to decrypt t, and gets the inner product t=θ^{T} as a signed integer of [symbol] .
4. In a final step, the client applies the g function to obtain the prediction fᵢ corresponding to input vector x.

A Second ‘Dual’ Protocol for Private Regression. The previous protocol encrypts using the client's public key pk_{c}. In the dual approach, the server's public key is used for encryption. Let (pkₛ, skₛ) denote the public/private key pair of the server for some additively homomorphic encryption scheme ({11., 0.}1). The message space [symbol] is unchanged.

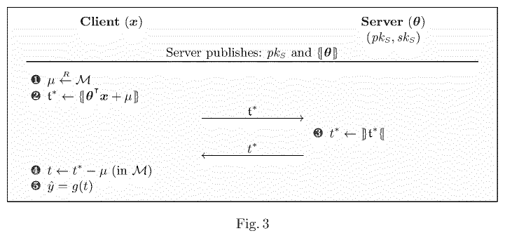

In this case, the server needs to publish an encrypted version [symbol] θ [symbol] of its model. The client must therefore get a copy of {θ} once, but can then engage in the protocol as many times as it wishes. One could also suppose that each client receives a different encryption of θ using a server's encryption key specific to the client, or that a key rotation is performed on a regular basis. The different steps are summarised in FIG. 3.

Since the mask μ is chosen uniformly at random in [symbol] , it is important to see that t*0′x+μ (mod [symbol] )) is uniformly distributed over [symbol] . Thus, the server gains no bit of information from t*.

Variant and Extensions. In a variant, in Step 2 of FIG. 2 (resp. Step 3 of FIG. 3), the server can add some noise E by defining t as t ← [symbol] θ^{T}x+e [symbol] = [symbol] θ^{T}x [symbol] [symbol] [symbol] ϵ [symbol] (resp. t* as t*← [symbol] t* [symbol] ). This presents the advantage of limiting the leakage on θ resulting from the output result. On the minus side, upon decryption, the client looses some precision in the so-obtained regression result.

The proposed methods are not limited to the identity map or the sigmoid function but may he generalised to any injective function g. This includes the tanh activation function alluded to in Section 2A where g(t)=tan h(t), as well as:

$$g ( t ) = arc tan ( t ) [ arc tan ] , \\ g ( t ) = t / ( 1 + \vert t \vert ) [ softsign ] , \\ g ( t ) = ln ( 1 + {e}^{t} ) [ softplus ] , \\ g ( t ) = \{ \begin{matrix}0.01 t & for t < 0 \\ t & for t ⩾ 0\end{matrix} [ leaky ReLU ] ,$$

and more. For any injective function g, there is no more information leakage in returning O^{T}x than returning g(θ^{T}x).

The described methods may be further generalized to non-injective functions g. However, in the case of non-injective functions g, there may in principle be more information leakage from returning θ^{T}x rather than returning g(θ^{T} x). How much more information leakage there may be depends on the particular function g.

### 5.3 Private SVM Classification

As discussed in Section 2.3, SVM inference can be abridged to the evaluation of the sign of an inner product. However, the sign function is clearly not injective. The methodology developed in the previous section is therefore not optimal in avoiding leakage. To minimize leakage, we require another method. An important element of such another method described below, is to make use of a privacy-preserving comparison protocol. For concreteness, we consider the DOK+protocol (cf. Section 3.3); but any privacy-preserving comparison protocol could be adapted.

A First ‘Nave’ Protocol for Private SVM Classification. A client holding a private feature vector x wishes to evaluate sign(θ′x) where θ parametrises an SVM classification model. In a first approach, the client can encrypt x (using an additively homomorphic encryption algorithm parameterized with a public key of the client) and send ∥x∥ to the server. Next, the server may choose or select in an unpredictable way a (preferably random) mask μ, and may compute ∥η∥=∥θ^{T}x+μ∥ for the chosen or selected mask μ. The server may send the resulting ∥η∥ to the client. The client may decrypt μημ (using an additively homomorphic decryption algorithm that matches the aforementioned additively homomorphic encryption algorithm and that is parameterized with a private key of the client that matches the aforementioned public key of the client) and recover η. Finally, the client and the server may engage in a private comparison protocol (such as the DGK±protocol) with respective inputs η and μ, and the client may deduce the sign of hex from the resulting comparison bit [μ≤η], i.e., if the comparison bit indicates that 77 is larger than ᵢt then the client may conclude that θ^{T}x is positive (and vice versa).

There are some issues associated with this first protocol. A first issue is that if we use the DGK+ protocol for the private comparison, at least one extra exchange from the server to the client is needed for the client to get [μ≤η]. This can be fixed by considering the dual approach. A second, more problematic, issue is that the decryption of [symbol] η [symbol] := [symbol] θ^{T}x+μ [symbol] yields ηas an element of [symbol] , which is not necessarily equivalent to the integer 0′x To solve this issue it is sufficient to ensure that the size of the message space [symbol] is sufficiently large to contain any possible value of Er x +_{f}t. More specifically, this problem can be solved by choosing [symbol] sufficiently large such that [symbol] /2 <6rx rtμ < [symbol] /2 1 for any possible values of 0, x and _{f}t. Thirdly, depending on the range of possible values of _{f}t, the value of 1₇ may leak information on 0′ x, To avoid or at least limit this leakage problem, the range of possible values of 1 is preferably chosen to be at least as large as the range of possible values of 1 and preferably as large as feasible. Finally, DGK+ does not apply to negative values. So, if we use the DGK+ protocol for the private comparison, it should be ensured that both 17 and ᵢx can only take on positive values. This can for example be ensured by ensuring that _{f}t is always larger than the absolute value of the minimum possible value of 0^{T}x.

A Second ‘Core’ Protocol for Private SVM Classification. In the following we apply the above mentioned solutions for the various mentioned issues. We suggest to select the message space much larger than the upper bound B on the inner product, so that the computation will take place over the integers. Specifically, if trx E [B, B] then, letting [symbol] indicate the bit-length of B, the message space [symbol] ={[M/2], , [M/21 is dimensioned such that M≥ [symbol] (2′⁻' ±1) 1 for a chosen security parameter r, and μ is an ( [symbol] +k)−bit integer that is chosen such that μ≥B. By construction we will then have 0≤θx+μ< [symbol] so that the decrypted value modulo [symbol] corresponds to the actual integer value.

We further present a refinement to optimise the bandwidth requirements. The refinement is based on the ide of privately comparing not the full values of μ and η,, but rather privately comparing the values μ, mod D and η mod D wherein D is an integer larger than [symbol] . The sign of θ′x can then be obtained from the comparison of μ mod D and ηmod D and the least significant bits of the integer divisions of μ and ηmod D, i.e., μ div D and η div D. The calculations are simplified if D is a power of 2. Furthermore, D is preferably as small as possible to limit the number of exchanges. It follows that preferably D= [symbol] . As a result, the number of exchanged ciphertexts depends on the length of B and not on the length of [symbol] (notice that M=# [symbol] ).

A protocol for private SVM classification of a feature vector x that addresses the above mentioned problems is the following:

0. The server may publish a server public key pkₛ and [symbol] θ [symbol] (i.e., the model parameters encrypted by the server using a first additively homomorphic encryption algorithm parameterized with the aforementioned server public key).

1. Let [symbol] be a chosen security parameter. The client starts by picking in an unpredictable manner, preferably uniformly at random, in [ [symbol] −1, [symbol] ) an integer μ= [symbol] μᵢ2ⁱ (wherein the coefficients _{[}Lᵢ are bit values).

2. In a second step, the client computes, over encrypted data, the inner product θ^{T} x and masks the result of this inner product computation with ᵢt, (by homomorphically adding _{f}t to the result of the inner product computation) to get t= [symbol] t [symbol] b 0 with t=θ−x+μas

$${t}^{*} = \{ [ {θ}_{0} ] \} ( {x}_{j} ⊙ \{ [ {θ}_{j} ] \} ) \{ [ μ ] \} .$$

3. Next, the client sends t* to the server.

4. Upon reception, the server decrypts t* to get t*:= [symbol] t* [symbol] mod M=θ^{T}x+μ.

5. The client determines the [symbol] -bit value μ:=μmod [symbol] = [symbol] μᵢ 2ⁱ. The server defines the [symbol] -bit integer η:=t*mod [symbol] .

6. A private comparison protocol, such as for example the DGK-H protocol (cf. Section 3.3), is now applied to the two [-bit values ₐ:=p, mod 2′ = [symbol] μᵢ 2ⁱ and η= [symbol] ηᵢ2ⁱ. 7. As a final step, the client obtains the predicted class from the result of said application of the private comparison protocol, [μ<η], for example by leveraging the relation

$$sign ( {θ}^{⊤} x ) = {( - 1 )}^{⫬ ( {t}_{ℓ}^{*} ⊕ {μ}_{ℓ} ⊕ [ \underline{μ} < η ] )}$$

with [symbol] :=└t*/ [symbol] ┘mod 2.

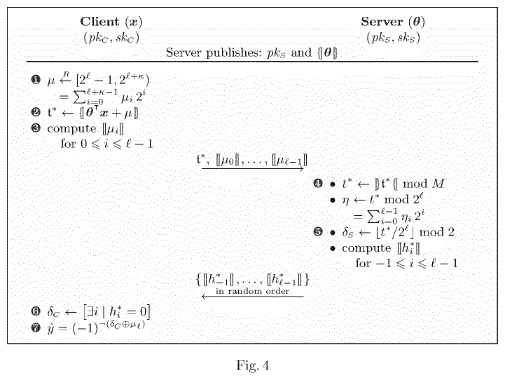

A particular version of this protocol that uses the DGK-H private comparison protocol is illustrated in FIG. 4 and includes the following steps:

0. The server may publish a server public key pkₛ and [symbol] θ [symbol] (i.e., the model parameters encrypted by the server using a first additively homomorphic encryption algorithm parameterized with the aforementioned server public key). 1. Let [symbol] be a chosen security parameter. The client starts by picking in an unpredictable manner, preferably uniformly at random, in [ [symbol] −1, [symbol] ) an integer μ= [symbol] μᵢ 2ⁱ (wherein the coefficients are bit values). 2. In a second step, the client computes, over encrypted data, the inner product O^{r}x and masks the result of this inner product computation with p (by homomorphically adding ᵢt to the result of the inner product computation) to get t*= [symbol] t* [symbol] with t*=θx+μas

$${t}^{*} = \{ [ {θ}_{0} ] \} ( {x}_{j} ⊙ \{ [ {θ}_{j} ] \} ) \{ [ μ ] \} .$$

3. Next, the client individually encrypts (using a second additively homomorphic encryption algorithm parameterized with a client public key) the first [symbol] bits of μwith its own encryption key (i.e., said client public key) to get [symbol] μᵢ [symbol] for 0≤t≤ [symbol] −1, and sends and the [symbol] μᵢ [symbol] 's to the server. To ensure that the server cannot deduce information on the value of p, it is preferable that the encryption algorithm that is used by the client to individually encrypt the first f bits of p,, be semantically secure. 4. Upon reception, the server decrypts t* to get t* := [symbol] t* [symbol] mod M=θ^{T}x+μand defines the [symbol] -bit integer η:=t* mod [symbol] . 5. The DGK+ protocol (cf. Section 3,3) is now applied to two [symbol] -bit values μ :=μmod [symbol] = [symbol] μᵢ [symbol] _{and η=} [symbol] _{η}ᵢ 2^{e}. The server selects bit number [symbol] of t* for 6, (i.e., 6, =1172^{e}] mod 2), defines s =1 26ₛ, and forms the [Thᵢl ‘s (with 1 G i f 1) as defined by Eq. (5). The server permutes randomly the [Thᵢl ‘s and sends them to the client. 6. The client decrypts the [Thl's and gets the hrs. If one of them is zero, it sets 6_{c} =1; otherwise it sets 5 =0. 7. As a final step, the client obtains the predicted class as ŷ=(−1 [symbol] , where [symbol] denotes bit number [symbol] of μ.

Again, the proposed protocol keeps the number of interactions between the client and the server to a minimum: a request and a response.

CORRECTNESS. To prove the correctness, we need the two following simple lemmata.

Lemma 1. Let a and b be two non-negative integers. Then for any positive integer n_{;} [(a b)/n] =[a/n] [b/n]+[((a mod n) (b mod n))/n] .

Proof. Write

$$a = ⌊ \frac{a}{n} ⌋ n + ( a mod n ) and b = ⌊ \frac{b}{n} ⌋ n + ( b mod n ) .$$

### Then

$$a - b = ( ⌊ \frac{a}{n} ⌋ - ⌊ \frac{b}{n} ⌋ ) n + ( a mod n ) - ( b mod n ) .$$

Recalling that for ηₒ ∈ [symbol] and x ∈ [symbol] , [x +nₒ]=[xi nₒ and [nₒ] =[nₒ], the lemma follows by integer division through n.

Lemma 2. Let a and b be two non-negative integers smaller than some positive integer n. Then [b <a] =1+[(a b)/n].

Proof. By definition 0≤a<n and 0<n. If b≤a then

$$0 ⩽ \frac{a - b}{n} < 1$$

and thus

$$⌊ \frac{a - b}{n} ⌋ = 0 ;$$

otherwise, if b>a then

$$- 1 < \frac{a - b}{n} < 0$$

and so

$$⌊ \frac{a - b}{n} ⌋ = - 1.$$

Remember that, by construction, O^{T}x E [B, B] with B =2^{e} 1, that μ∈[ [symbol] −1, [symbol] ), and by definition that t* := [symbol] t* [symbol] mod M with t* = [symbol] θ^{t}x+μ [symbol] . Hence, in Step 4, the server gets t* =8′×+p mod [symbol] =0^{T}x +μ(over [symbol] ) since 0≤θ^{T}x+μ≤ [symbol] −1+ [symbol] −1<M. Let δ:=δ_{c}⊕δₛ[μ≤η](with μ :=μmod [symbol] and η:=t* mod [symbol] ) denote the result of the private comparison in Steps 5 and 6 with the DGK-H protocol.

Either of those two conditions holds true

$$\{ \begin{matrix}0 ⩽ {θ}^{T} x < {2}^{ℓ} ⟺ 1 ⩽ \frac{{θ}^{T} x + {2}^{ℓ}}{{2}^{ℓ}} < 2 ⟺ ⌊ \frac{{θ}^{T} x + {2}^{ℓ}}{{2}^{ℓ}} ⌋ = 1 \\ - {2}^{ℓ} < {θ}^{T} x < 0 ⟺ 0 < \frac{{θ}^{T} x + {2}^{ℓ}}{{2}^{ℓ}} < 1 ⟺ ⌊ \frac{{θ}^{T} x + {2}^{ℓ}}{{2}^{ℓ}} ⌋ = 0\end{matrix} ,$$

and so

$$\begin{matrix}[ {θ}^{T} x ⩾ 0 ] & = ⌊ \frac{{θ}^{T} x + {2}^{ℓ}}{{2}^{ℓ}} ⌋ = ⌊ \frac{{t}^{*} - μ}{{2}^{ℓ}} ⌋ + 1 & since {t}^{*} = {θ}^{T} x + μ \\ & = ⌊ \frac{{t}^{*}}{{2}^{ℓ}} ⌋ - ⌊ \frac{μ}{{2}^{ℓ}} ⌋ + ⌊ \frac{η - \underline{μ}}{{2}^{ℓ}} ⌋ + 1 & by Lemma 1 \\ & = ⌊ \frac{{t}^{*}}{{2}^{ℓ}} ⌋ - ⌊ \frac{μ}{{2}^{ℓ}} ⌋ + δ & by Lemma 2 \\ & = ( ⌊ \frac{{t}^{*}}{{2}^{ℓ}} ⌋ - ⌊ \frac{μ}{{2}^{ℓ}} ⌋ + δ ) mod 2 & since [ {θ}^{T} x ⩾ 0 ] ∈ \{ 0 , 1 \} \\ & = ( ⌊ \frac{μ}{{2}^{ℓ}} ⌋ + {δ}_{C} ) mod 2 & since {δ}_{S} = ⌊ {t}^{*} / {2}^{ℓ} ⌋ mod 2 \\ & = {μ}_{ℓ} ⊕ {δ}_{C} . & \end{matrix}$$

Now, noting sign (θ′x)=(−1), we get the desired result.

### SECURITY. The security of the protocol of FIG. 1—follows from the fact that the inner product O^{T}x is statistically masked by the random value Security parameter guarantees that the probability of an information leak due to a carry is negligible. The size of this security parameter may have an impact on the overall security. in general, the larger the value of n, the higher the security. The value of is preferably minimally in the order of for example 80. A suitable value for i may for example be 128. The security also depends on the security of the private comparison protocol, which in the case of the DGK+ comparison protocol is ensured since the DGIc+ comparison protocol is provably secure (cf. Remark 3).

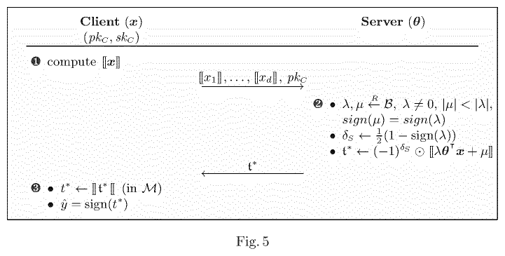

A Third ‘Heuristic’ Protocol. The previous protocol, thanks to the use of the DGIK+algorithm offers provable security guarantees but incurs the exchange of 2( [symbol] +1) ciphertexts. Here we aim to reduce the number of ciphertexts and introduce a new heuristic protocol that is summarised in FIG. 5, This protocol requires the introduction of a signed factor A, such that >4.ck and we now use both ᵢt and A to mask the model. To ensure that AO^{T}x p remains within the message space, A should also verify A E [symbol] where

$$ℬ := [ - ⌊ \frac{⌈ M / 2 ⌉}{B + 1} ⌋ , ⌊ \frac{⌈ M / 2 ⌉}{B + 1} ⌋ ] .$$

Furthermore, to ensure the effectiveness of the masking, [symbol] should be sufficiently large; namely, # [symbol] > [symbol] for a security parameter ii, hence M> [symbol] [symbol] −1). Also for this protocol, the size of this security parameter k may have an impact on the overall security. In general, the larger the value of ti, the higher the security. The value of ,v is preferably minimally in the order of for example 80. A suitable value for K may for example be 128.

The protocol which is illustrated in FIG. 5 runs as follows;

1. The client encrypts its input data x using its public key, and sends its key and the encrypted data to the server. 2. The server draws at random a signed scaling factor A E [symbol] , A =0, and an offset factor μ∈ [symbol] such that 4/1 <A. The server then defines the bit 5, such that sign(A) =(-1)⁶⁵ and computes an encryption 1,* of the shifted and scaled inner product t* =(-1)^{a5} (A0^{T} x t p) as

$${t}^{*} = 〚 {( - 1 )}^{{δ}_{S}} μ 〛 + {+}_{i = 0}^{d} ( {( - 1 )}^{{δ}_{S}} λ {θ}_{i} ) ⊙ 〚 {x}_{i} 〛 ,$$

and sends t* to the client. Note that instead, one could define λ, μ [symbol] with λ<0 and |μ|>λ, and t*=λθ^{T}x+μ. We however prefer the other formulation as it easily generalises to extended settings (see Section 6.2).

3. In the final step, the client decrypts t* using its private key, recovers t* as a signed integer of [symbol] , and deduces the class of the input data as fi =sign(t*).

CORRECTNESS. The constraint /_/1 <A with A =0 ensures that fi =sign(0^{T}x). Indeed, as (−1)⁶s =sign(A), we have t*=(1)⁶s (A0^{T}x p) =N6^{4-r}x (-1)⁸sp, =‘x +e) with e :=(1)⁸sp/Rq. Hence, whenever O^{T}x # 0, we get =sign(t*) =sign(0^{T}x ₊e)=sign(0^{T}x) since .9′×>1 and e =ᵢ/ON <1.

SECURITY. We stress that the private comparison protocol we use in FIG. 5 does not come with formal security guarantees. In particular, the client learns the value of t*=AO^{T} x with λ, μ∈ [symbol] and 4/1 <)'h Some information on t :=° ^{T}x may be leaking from t* and_{;} in turn, on 0 since x is known to the client. The reason resides in the constraint 4/1 <AI. So, from t*=AO^{T} x we deduce log t* G log1N +log (t1 +1). For example, when t has two possible very different “types” of values (say, very large and very small), the quantity logr can be enough to discriminate with non-negligible probability the type of t. This may possibly leak information on O. That does not mean that the protocol is necessarily insecure but it should be used with care.

Remark 5. The bandwidth usage could be even reduced to one ciphertext and a single bit with the dual approach. From the published encrypted model [symbol] 9 [symbol] , the client could homomorphically compute and send to the server t*= [symbol] λθ^{T}x+μ [symbol] for random λ, μ∈ [symbol] with 4/1 <The server would then decrypt t*, obtain t*, compute

$${δ}_{S} = \frac{1}{2} ( 1 - sign ( {t}^{*} ) ) ,$$

and return to the client. Analogously to the primal approach, the output class ŷ=sign(θ^{T}x) is obtained by the client as fi=(−1)⁶s sign(A). However, and contrarily to the primal approach, the potential information leakage resulting from t* in this case on x is now on the server's side, which is in contradiction with our Requirement #1 (input confidentiality), We do not further discuss this variant,

### 6 Application to Neural Networks

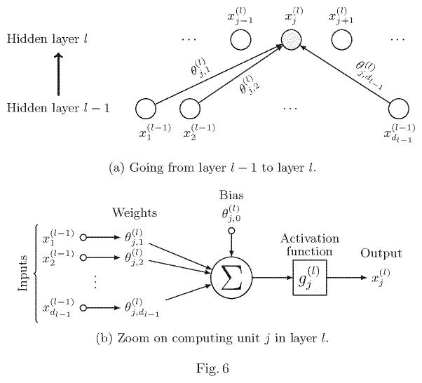

Typical feed-forward neural networks are represented as large graphs. Each node on the graph is often called a unit, and these units are organised into layers. At the very bottom is the input layer with a unit for each of the coordinates xⱼ⁽⁰⁾ of the input vector)x(° :=x E X. Then various computations are done in a bottom to top pass and the output y E [symbol] comes out all the way at the very top of the graph. Between the input and output layers a number of hidden layers are evaluated. We index the layers with a superscript (1), where 1=0 for the input layer and 1<l<L for the hidden layers. Layer L corresponds to the output. Each unit of each layer has directed connections to the units of the layer below; see FIG. 6a.

FIG. 6b details the outcome 4) of the j^{th} computing unit in layer 1. We keep the convention x(₀¹) :=1 for all layers. If we note θⱼ^{(l)} the vector of weight coefficients θ_{j,k}^{(l)} (k, 0 G k G d₁, where d₁ is the number of units in layer 1, then x(^{I}) can be expressed as:

$$\begin{matrix}{x}_{j}^{( l )} = {g}_{j}^{( l )} ( {( {θ}_{j}^{( l )} )}^{T} {x}^{( l - 1 )} ) \\ = {g}_{j}^{( l )} ( {θ}_{j , 0}^{( l )} + {\sum }_{k = 1}^{{d}_{l + 1}} {θ}_{j , k}^{( l )} {x}_{j}^{( l - 1 )} ) , 1 ⩽ j ⩽ {d}_{l} .\end{matrix} \qquad ( 6 )$$

Functions gⱼ^{(l)} are non-linear functions such as the sign function or the Rectified Linear Unit (ReLU) function

Those functions are known as activation functions. Other examples of activation functions are defined in Section 52.

The weight coefficients characterise the model and are known only to the owner of the model. Each hidden layer depends on the layer below, and ultimately on the input data x⁰), known solely to the client.

### 6.1 Generic Solution

On the basis of Equation (6) the following generic solution can easily be devised: for each inner product computation, and therefore for each unit of each hidden layer, the server computes the encrypted inner product and the client computes the output of the activation function in the clear. In more detail, the evaluation of a neural network can go as follows.

0. The client starts by encrypting its input data and send it to the server.

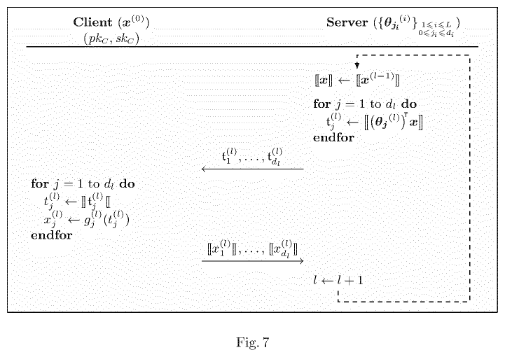

1. Then, as illustrated in FIG. 7, for each hidden layer 1,1,<1<L:
(a) The server computes d₁ encrypted inner products tⱼ corresponding to each unit j of the layer and sends those to the client.
(b) The client decrypts the inner products, applies the required activation (6 function gⱼ⁽ⁱ⁾, re-encrypts, and sends back d₁ encrypted values.

2. During the last round (=L), the client simply decrypts the fⱼ values and applies the corresponding activation function g ⱼ^{(L)} to each unit j of the output layer. This is the required result.

For each hidden layer 1, exactly two messages (each comprising d₁ encrypted values) are exchanged. The input and output layers only involve one exchange; from the client to the server for the input layer and from the server back to the client for the output layer.

Several variations are considered in [3]. For increased security, provided that the units feature the same type of activation functions in a given layer 1 (i.e., gₙ =g₂ =g_{di}), the server may first apply a random permutation on all units (i.e., sending the t₁′s in a random order), It then recovers the correct ordering by applying the inverse permutation on the received [symbol] x(Pll ‘s. If units in different layers use the same type of activation functions and at least some units don't require the outputs of all units in the layer below, then it is possible, to some extent, to also permute the order of unit evaluation not just within a given layer but even between different layers. The server may also want to hide the activation functions. In this case, the client holds the raw signal t₃ :=t(¹)=(9ⱼ(^{I}T x and the server the corresponding activation function gC^{l}). The suggestion of [3] is to approximate the activation function as a polynomial and to rely on oblivious polynomial evaluation [18] for the client to get xⱼ^{(l)≈P}ⱼ^{(l)}(tⱼ) without learning polynomial Pr approximating gY). Finally, the server may desire not to disclose the topology of the network. To this end, the server can distort the client's perception by adding dummy units and/or layers.

An issue of the above described generic solution is that, in order to apply the activation functions, the client must decrypt the inner products and thus gets access to the values of the inner products, which may leak information about the neural network model parameters. In the following two sections, we improve the generic solution for two popular activation functions: the sign and the ReLU functions. In the new proposed implementations, everything is kept encrypted from start to end. The raw signals are hidden from the client's view in all intermediate computations.

### 6.2 Sign Activation

Binarized neural networks implement the sign function as activation function. This is very advantageous from a hardware perspective [13].

Section 5.3 describes two protocols for the client to get the sign of θ^{T}x. In order to use them for binarized neural networks in a setting similar to the generic solution, the server needs to get an encryption of sign(O^{T}i) for each computing unit j in layer 1 under the client's key from [symbol] x [symbol] , where [symbol] x [symbol] := [symbol] x^{l-1}) [symbol] is the encrypted output of layer/1 and 0:=Oᵢ(ⁱ) is the parameter vector for unit j in layer l.

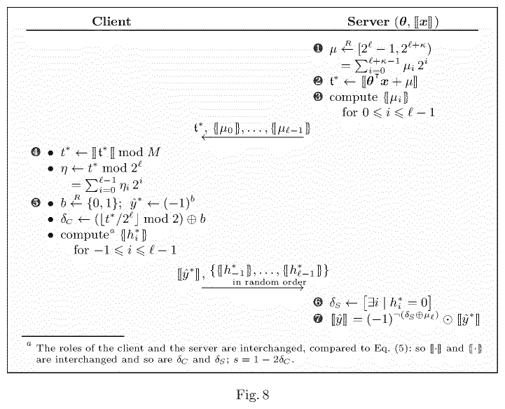

We start with the core protocol of FIG. 4. It runs in dual mode and therefore uses the server's encryption. Exchanging the roles of the client and the server almost gives rise to the sought-after protocol. The sole extra change is to ensure that the server gets the classification result encrypted. This can be achieved by masking the value of 6, with a random bit 1) and sending an encryption of (−1)^{b}. The resulting protocol is depicted in FIG. 8.

In the heuristic protocol (cf. FIG. 5), the server already gets an encryption of [symbol] x [symbol] as an input. It however fixes the sign of t* to that of irx. If now the server flips it in a probabilistic manner, the output class (i.e., sign(0^{1[}x)) will be hidden from the client's view. We detail below the modifications to be brought to the heuristic protocol to accommodate the new setting:

In Step 2 of FIG. 5, the server keeps private the value of 6 by replacing the definition of 1* with t* =[PkO^{r}x +ᵢtll In Step 3 of FIG. 5, the client then obtains fj* :=sign(O^{T}x) (-1)⁶s and returns its encryption Ffi*1] to the server. The server obtains bl] as bll =(-1)⁸s r,_;:.) b*1].

If 0 :=0 (¹) and [1x1] [Ix(^{/})1] then the outcome of the protocol of FIG. 8 (/) or of the modified heuristic protocol is =[1: r 1. Of course, this can be done in parallel for all the dᵢ units of layer I (i.e., for 1 <j G dᵢ; see Eq. (6)), yielding [1x(⁰1] =(NI , Qxi 0 , _{[1x}; _{1]}). _{This means that just one round of} communication between the server and the client suffices per hidden layer, 6.3 ReLU Activation

A widely used activation function is the ReLU function. It allows a network to easily obtain sparse representations and features cheaper computations as there is no need for computing the exponential function [9].

Letting 3(t)=[t <0] E {0, 1}, we can write sign(t) =(-1)⁰³(¹) and

$$ReLU ( t ) = ( 1 - β ( t ) ) \cdot t . \qquad ( 7 )$$

Back to our setting, the problem is for the server to obtain Relut from VI], where t=0′x with x:=x(¹⁻¹) and 0:=o(¹) , in just one round of communication per hidden layer. We saw in the previous section how to do it for the sign function. The Belli function is more complex to apprehend. If we use Equation (7), the difficulty is to let the server evaluate a product over encrypted data.

It is an insight of the inventors that the protocols developed in the previous section can be reformulated so that the client and the server secret-share the comparison bit [0^{1[}x >0]. To do so, the server chooses a random maskμ E [symbol] and “super-encrypts” [10′4 as [[0¹″x ±ᵢd. The client re-randomises it as t* := [symbol] θ^{T}x+μ [symbol] [symbol] [symbol] 0 [symbol] , computes o := [symbol] 0 [symbol] , and returns the pair (o, t*) or (t*, o), depending on its secret share. The server uses its secret share to select the correct item and “decrypts” it. If the server (obliviously) took o it already has the result in the right form; i.e., [symbol] 0 [symbol] . Otherwise the server has to remove the maskμ so as to [symbol] θ^{T}x [symbol] ←t* [symbol] [symbol] μ [symbol] . In order to allow the server to (obliviously) remove or not the mask, the client also sends an encryption of the pair index; e.g., 0 for the pair (o, t*) and 1 for the pair (t*, o).

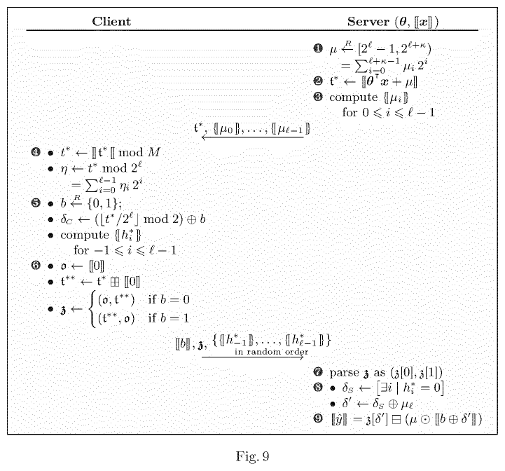

FIG. 9 details an implementation of this with the DGK+ comparison protocol. Note that to save on bandwidth the same maskμ is used for the comparison protocol and to “super-encrypt” [symbol] θ^{T}x [symbol] .

The heuristic protocol can be adapted in a similar way.

Remark 6. It is interesting to note that the new protocols readily extend to any piece-wise linear function, such as the clip function

$$clip ( t ) = max ( 0 , min ( 1 , \frac{t + 1}{2} ) )$$

(a.k.a. hard-sigmoid function).

A number of embodiments and implementations of the invention have been described. Nevertheless, it will be understood that various modifications may be made. For example, elements of one or more implementations may be combined, deleted, modified, or supplemented to form further implementations. Accordingly, other implementations are within the scope of the appended claims. In addition, while a particular feature may have been disclosed with respect to only one of several implementations, such feature may be combined with one or more other features of the other implementations as may be desired and advantageous for any given or particular application. While various embodiments have been described above, it should be understood that they have been presented by way of example only, and not limitation. In particular, it is, of course, not possible to describe every conceivable combination of components or methodologies for purposes of describing the claimed subject matter, but one of ordinary skill in the art may recognize that many further combinations and permutations are possible. Thus, the breadth and scope of the teachings herein should not be limited by any of the above described exemplary embodiments.

The following list of documents are referenced in this description and are hereby incorporated by reference:

### References

1. Abu-Mostafa, Y.S., Magdon-Ismail, [symbol] ., Lin, H.T.: Learning From Data: A Short Course. AMLbook.com (2012), http://amlbook. corn
2. Agrawal, R., Srikant, R.: Privacy-preserving data mining. ACM Sigmod Record 29(2), 439-450 (2000). doi: H1111⁵/₃35191,335136
3. Sarni, [symbol] ., Orlandi, C., Piva, A.: A privacy-preserving protocol for neural-network- based computation. In: Voloshyriovskiy, S., Dittmann, J., Fridrich, .J.J. (eds.) 8th Workshop on Multimedia and Security (MNISzSec ‘06). pp. 146-151. ACM Press (2006). doi: 1111115/1161366,1161393
4. Bos, J. W., Lauter, K., Naehrig, N I.: Private predictive analysis on encrypted medical data. Journal of Biomedical Informatics 50,234-243 (2014). doi: 10.1016/j.jbi.2014.04.003
5. Damghrd, I., Geisler, [symbol] ., Kroigaard, [symbol] .: Homomorphic encryption and secure comparison. International Journal of Applied Cryptography 1(1), 22-31 (2008). doi: 10.1504/1JACT.2008.017048
6. Damgfird, I., Geisler, [symbol] ., Kroigaard, [symbol] .: A correction to ‘efficient and secure comparison for on-line auctions’. International Journal of Applied Cryptography 1(4), 323-324 (2009). doi:10,1561/41ACT,21109.02811111
7. Erkin, Z., Franz, [symbol] ., Guajardo, J., Katzenbeisser, S., Lagendijk, I., Toft, T.:

Privacy-preserving face recognition. In: Goldberg, I., Atallah, [symbol] .J. (eds.) Privacy Enhancing Technologies (PETS 2009). Lecture Notes in Computer Science, vol. 5672, pp. 235-253. Springer (2009). doi: 10.1007/978-3-6-12-03 168-7_11
8. Gentry, C.: Fully homomorphic encryption using ideal lattices. In: Mitzertmacher,

[symbol] . (ed.) 41st Annual ACM Symposium on Theory of Computing (STOC). pp. 169-178. ACM Press (2009). doi: HI.11H7,/1536-111.1ro36-1-10
9. Glorot, X., Bordes, A., Bengjio, Y.: Deep sparse rectifier neural networks. In:

14th International Conference on Artificial Intelligence and Statistics (AISTAT). Proceedings of Machine Learning Research, vol. 15, pp. 315-323. PMLR (2011), fittₚ://ₚroceefiings,m1r,press/v15/glorotila/giorotl la .pdf
10. Goethals, B., Laur, S., Lipmaa, H., Mielikainen, T.: On private scalar product computation for privacy-preserving data mining. In: Park, C., Chee, S. (eds.) Information Security and Cryptology - ICISC 2004. Lecture Notes in Computer Science, vol. 3506, pp. 104-102. Springer (2004). doi:16.10117/ I-190618_9
11. Goldwasser, S., Micah, S.: Probabilistic encryption. Journal of Computer and System Sciences 28(2), 270-299 (1984). doi:10.1016/0022-uuou(8-1)907(1-9
12. Hastie, T., Tibshirani, R., Friedman, J.: The Elements of Statistical Learning.

Springer Series in Statistics, Springer, 2nd edn. (2009). doi: Hi.1007/978 S-1658-7
13. Hubara, I., Courbariaux, lvi., Soudry, D., El-Yaniv, R., Bengio, Y.: Binarized neural networks. In: Lee, D.D., et al. (eds.) Advances in Neural Information Processing Systems 29 (NIPS 2016). pp. 4107-4115 (Curran Associates, Inc), http://papers nips,cc/paper/6573-binarized-neural-networks,pdt
14. Joye, [symbol] ., Salehi, F.: Private yet efficient decision tree evaluation. In: Kerschbaum, F., Paraboschi, S. (eds.) Data and Applications Security and Privacy XXXII (DB-Sec 2018). Lecture Notes in Computer Science, vol. 10980, pp. 243-259. Springer (2018). doi: 6_16
15. Kim, [symbol] ., Song, Y., Wang, S., Xia, Y., Jiang, X.: Secure logistic regression based on homomorphic encryption: Design and evaluation. JMIR Medical Informatics 6(2), e19 (2018). doi: 10.219G/Inedinfiirm,8805
16. Lindell, Y., Pinkas, B.: Privacy preserving data mining. In: Bellare, [symbol] . (ed.)

Advances in Cryptology - CRYPTO 2000. Lecture Notes in Computer Science, vol. 1880, pp. 36-54. Springer (2000). doi: 10.1H07,¹110-1-1598-6_3
17. Mohassel, P., Zhang, Y.: SecureML: A system for scalable privacy-preserving machine learning. In: 2017 IEEE Symposium on Security and Privacy. pp. 19-38. IEEE Computer Society (2017). doi: 10,1 tU9.1til″,20 I 7. [2
18. Naor, [symbol] ., Pinkas, B.: Oblivious polynomial evaluation. SIAM Journal on Computing 35(5), 1254-1281 (2006). doi: 10.1 [37/800975397o-1:483653
19. Paillier, P.: Public-key cryptosystems based on composite degree residuosity classes. In: Stern, J. (ed.) Advances in Cryptology EUROCRYPT ‘99. Lecture Notes in Computer Science, vol. 1592, pp. 223-238. Springer (1999). doi: 10,107/3-i1891H-X_16
20. Trainer, F., Zhartg, F., Juels, A., Reiter, [symbol] . K., Ristenpart, T.: Stealing machine learning models via prediction APIs. In: Holz, T., Savage, S. (eds.) 25th USENIX Security Symposium. pp. 601-618. USENIX Association (2016), https://www.usenix.org/system/files/conference/usenixsecurity16/sec16_paper_tramer.pd±21. Veugen, T.: Improving the DGK comparison protocol. In: 2012 IEEE International

Workshop on Information Forensics and Security (WIFS). pp. 49-54. IEEE (2012). doi: li(11U9/\11['S211) [2.04 [2021 22. Zhang, J., Wang, X., Yiu, S. [symbol] ., Jiang, Z. L., Li, J.: Secure dot product of out-sourced encrypted vectors and its application to SVM. In: Wang, C., Kantarcioglu, [symbol] . (eds.) Fifth ACM International Workshop on Security in Cloud Computing (SCC©AsiaCCS 2017). pp. 75-82. ACM (2017). doi: 1(41115/3W

FIG. 1 A server offering MEaaS owns a model 0 defined by its parameters. A client needs the prediction hₒ(x) of this model for a new input data x. This prediction is a function of the model and of the data.

FIG. 2 Privacy-preserving regression. Encryption is done using the client's public key and noted [symbol] . The server learns nothing, Function g is the identity map for linear regression and the sigmoid function for logistic regression.

FIG. 3 Dual approach for privacy-preserving regression. Here, encryption is done using the server's public key pk, and noted [symbol] . Function g is the identity map for linear regression and the sigmoid function for logistic regression.

FIG. 4 Privacy-preserving SVM classification. The detailed computation of the [symbol] hᵢ* [symbol] 's is given in Section 3.3. Note that some data is encrypted using the client's public key pk,, while other data is encrypted using the server's public key pkₛ. They are noted [symbol] and [symbol] respectively.

FIG. 5 Primal approach of another ‘heuristic’ protocol for privacy-preserving SVM classification.

FIG. 6 Relationship between a hidden unit in layer 1 and the hidden units of layer 11 in a simple feed-forward neural network.

FIG. 7 Generic solution for privacy-preserving evaluation of feed-forward neural networks. Evaluation of hidden layer 1.

Fig 8 Privacy-preserving binary classification with inputs and outputs encrypted under the client's public key. This serves as a building block for the evaluation over encrypted data of the sign activation function in a neural network,

FIG. 9 Privacy-preserving ReLU evaluation with inputs and outputs encrypted under the client's public key. The first five steps are the same as in FIG. 8. This building block is directed to neural networks using the ReLU activation and shows the computation for one unit in one hidden layer. We abuse they notation to mean either the input to the next layer or the final output. We recall foot note Footnote 1 in the computation of Step 9.

What is claimed is:

1. A method for evaluating a Machine Learning regression model in a privacy-preserving way, the method comprising the steps of:
at a server, storing a set of Machine Learning model parameters;
at a client, obtaining a feature vector the components of which are represented as integers;
at the client, encrypting the feature vector by encrypting each of the components of the feature vector using an additively homomorphic encryption algorithm that is parameterized with a public key of the client;
at the server, receiving the encrypted feature vector;
at the server, computing an encrypted value of an inner product of a model parameter vector and the feature vector, wherein:
the components of the model parameter vector consist of the values of the Machine Learning model parameters comprised in the set of Machine Learning model parameters;
the components of the model parameter vector are represented as integers; and
computing the encrypted value of said inner product of said model parameter vector and said feature vector is done by homomorphically computing an inner product of the model parameter vector with the received encrypted feature vector, wherein homomorphically computing the inner product of the model parameter vector with the received encrypted feature vector comprises computing for each component of the encrypted feature vector a term value by repeatedly homomorphically adding said each component of the encrypted feature vector to itself as many times as indicated by the value of the corresponding component of the model parameter vector and then homomorphically adding together the resulting term values of all components of the encrypted feature vector;
at the server, determining a server result as a server function of the resulting computed encrypted value of the inner product of the model parameter vector and the feature vector;
at the client, receiving the server result that has been determined the server;
at the client, decrypting the received server result using an additively homomorphic decryption algorithm that matches said additively homomorphic encryption algorithm, with a private key of the client that matches said public key of the client; and
at the client, computing a Machine Learning model result by evaluating a client function of the decrypted received server result.

2. The method of claim 1, wherein the client function of the decrypted received server result comprises the identity mapping function.

3. The method of claim 1, wherein the client function of the decrypted received server result comprises a non-linear injective function.

4. The method of claim 1 wherein the server determining the server result as a server function of the resulting computed encrypted value of the inner product of the feature vector and the model parameter vector comprises the server setting the value of the server result to the value of the resulting computed encrypted value of the inner product of the feature vector and the model parameter vector.

5. The method of claim 1 wherein the server determining the server result as a server function of the resulting computed encrypted value of the inner product of the feature vector and the model parameter vector comprises the server:
determining the value of a noise term,
homomorphically adding said value of the noise term to said computed encrypted value of the inner product of the feature vector and the model parameter vector, and
setting the value of the server result to the homomorphic addition of said value of the noise term and said computed encrypted value of the inner product of the feature vector and the model parameter vector.

6. The method of claim 1 wherein the client obtaining the feature vector comprises the client extracting an intermediate vector from gathered data and determining the components of the feature vector as a function of the components of the intermediate vector, wherein determining the components of the feature vector as a function of the components of the intermediate vector comprises calculating at least one component of the feature vector as a product of a number of components of the intermediate vector.

7. The method of claim 1 wherein the additively homomorphic encryption and decryption algorithm comprise Paillier's cryptosystem.

8. A method for evaluating a Machine Learning regression model in a privacy-preserving way, the method comprising the steps of:
at a server, storing a set of Machine Learning model parameters;
at the server, encrypting a model parameter vector, wherein:
the components of the model parameter vector consist of the values of the Machine Learning model parameters comprised in the set of Machine Learning model parameters;
the components of the model parameter vector may be represented as integers; and
the server encrypts the model parameter vector by encrypting each of the components of the model parameter vector using an additively homomorphic encryption algorithm that is parameterized with a public key of the server;
at the client, obtaining the encrypted model parameter vector;
at the client, obtaining a feature vector the components of which are represented as integers;
at the client, computing the encrypted value of the inner product of the model parameter vector and the feature vector by homomorphically computing the inner product of the received encrypted model parameter vector with the feature vector, wherein homomorphically computing the inner product of the received encrypted model parameter vector with the feature vector consists of computing for each component of the encrypted model parameter vector a term value by repeatedly homomorphically adding said each component of the encrypted model parameter vector to itself as many times as indicated by the value of the corresponding component of the feature vector and then homomorphically adding together the resulting term values of all components of the encrypted model parameter vector;
at the client, determining an encrypted masked client result as a function of the computed encrypted value of the inner product of the model parameter vector and the feature vector;
at the server, receiving the encrypted masked client result that has been determined by the client;
at the server, decrypting the received encrypted masked client result using an additively homomorphic decryption algorithm that matches said additively homomorphic encryption algorithm with a private key of the server that matches said public key of the server;
at the server, determining a masked server result as a server function of the result of the server decrypting the received encrypted masked client result;
at the client, receiving the masked server result that has been determined by the server;
at the client determining an unmasked client result as a function of the received masked server result; and
at the client computing a Machine Learning model result by evaluating a client function of the determined unmasked client result.

9. The method of claim 8, wherein the client function of the decrypted received server result comprises the identity mapping function.

10. The method of claim 8, wherein the client function of the decrypted received server result comprises a non-linear injective function.

11. The method of claim 8 wherein the server determining the masked server result as a server function of the result of the server decrypting the received encrypted masked client result comprises the server setting the value of the masked server result to the value of the result of the server decrypting the received encrypted masked client result.

12. The method of claim 8 wherein the server determining the masked server result as a server function of the result of the server decrypting the received encrypted masked client result comprises the server determining the value of a noise term, homomorphically adding said value of the noise term to said result of the server decrypting the received encrypted masked client result, and setting the value of the masked server result to the homomorphic addition of said value of the noise term and said result of the server decrypting the received encrypted masked client result.

13. The method of claim 8 wherein the client extracting the feature vector comprises the client extracting an intermediate vector from the gathered data and determining the components of the feature vector as a function of the components of the intermediate vector wherein determining the components of the feature vector as a function of the components of the intermediate vector comprises calculating at least one component of the feature vector as a product of a number of components of the intermediate vector wherein at least one component of the intermediate vector appears multiple times as a factor in said product.

14. The method of claim 8 wherein the additively homomorphic encryption and decryption algorithm may comprise Paillier's cryptosystem.

15. The method of claim 8 whereby
the client determining the encrypted masked client result as a function of the computed encrypted value of the inner product of the model parameter vector and the feature vector comprises the client setting the value of the masked client result to the value of the computed encrypted value of the inner product of the model parameter vector and the feature vector; and
the client determining the unmasked client result as a function of the received masked server result comprises the client setting the value of the unmasked client result to the value of the received masked server.

16. The method of claim 8 whereby
the client determining the encrypted masked client result as a function of the computed encrypted value of the inner product of the model parameter vector and the feature vector may comprise
the client determining a masking value,
the client encrypting the determined masking value by using said additively homomorphic encryption algorithm parameterized with said public key of the server, and
the client setting the value of the masked client result to the result of homomorphically adding the encrypted masking value to said computed encrypted value of the inner product of the model parameter vector and the feature vector; and
whereby the client determining the unmasked client result as a function of the received masked server result may comprise the client setting the value of the unmasked client result to the result of subtracting said determined masking value from the received masked server result.

17. A method for private support vector machine classification of a feature vector x comprising the steps of:
a server publishing a server public key pk_{S} and [symbol] θ [symbol] wherein θ is a model parameter vector the components of which consist of the values of the parameters of a Machine Learning model whereby said components are represented as integers and wherein [symbol] θ [symbol] is the encryption of said model parameter vector by the server using a. first additively homomorphic encryption algorithm parameterized with the aforementioned server public key;
a client obtaining said feature vector x, whereby the components of said feature vector are represented as integers;
the client picking [ [symbol] −1, [symbol] ) an integer μ= [symbol] μᵢ2ⁱ, wherein indicates the bit-length of an upperbound B on the value of the inner product θ^{T}x, the coefficients μ_{I} are bit values and γ is a chosen security parameter;
the client computing, over encrypted data, said inner product θ^{t}x and masking the result of this inner product computation with by homomorphicany adding p, to the result of the inner product computation to get t* = [symbol] t* [symbol] with t*=θ^{t}X+μ as
$${t}^{*} = \{ [ {θ}_{0} ] \} ( {x}_{j} ⊙ \{ [ {θ}_{j} ] \} ) \{ [ μ ] \} ;$$
the server receiving t* computed by the client;
the server decrypting the received t* to get t*:= [symbol] t* [symbol] mod M
the client determining an [symbol] -bit integer value g :=p.mod
the server determining an f-bit integer value r:=t* mod
the server and the client applying a private comparison protocol to the
two £-bit values μ and η;
the client obtaining a predicted class from the result of said application of said private comparison protocol.

18. The method of method 17, wherein said obtaining a predicted class from the result of said application of said private cornuarison protocol comprises leveraging the relation
$$sign ( {θ}^{⊤} x ) = {( - 1 )}^{⫬ ( {t}_{ℓ}^{*} ⊕ {μ}_{ℓ} ⊕ [ \underline{μ} < η ] )}$$
with [symbol] :=[t8/2]mod 2.
